(19) United States
(12) Patent Application Publication
(10) Pub. No.: US 2026/0239118 A1
(43) Pub. Date: Aug. 13, 2026

(54) PREDICTION OF TARGET CELL AND HANDOVER TIME TO LIMIT UNNCECESSARY HANDOVER

(71) Applicant: Nokia Technologies Oy, Espoo (FI)

(72) Inventors: Hans Thomas HÖHNE, Espoo (FI); Jian SONG, Massy (FR); Vismika Maduka RANASINGHE MUDIYANSELAGE, Oulu (FI); Tachporn SANGUANPUAK, Oulu (FI)

(21) Appl. No.: 19/155,466

(22) PCT Filed: Feb. 5, 2024
(86) PCT No.: PCT/EP2024/052707

§ 371 Date: Aug. 11, 2025

(30) Foreign Application Priority Data
Feb. 22, 2023 (GB) 2302472.2

(51) Int. Cl. H04W 36/00; H04W 36/08

(52) U.S. Cl. CPC H04W 36/0061; H04W 36/08

(57) ABSTRACT

There is provided a method, computer program and apparatus for causing a user equipment to perform: receiving, from a network, an indication of a first time duration and an indication of at least one metric to be predicted within the first time duration for at least a serving cell and a plurality of target cells of the network; receiving, from the network, an indication of how to identify potential handover opportunities between the serving cell and at least one of the plurality of target cells within the first time duration using the at least one metric; identifying a first set of potential handover opportunities between the serving cell and at least one of the plurality of target cells within the first time duration using the at least one metric; and signalling an indication of at least one of said first set of potential handover opportunities to the network.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided a method for a user equipment, the method comprising: receiving, from a network, an indication of a first time duration and an indication of at least one metric to be predicted within the first time duration for at least a serving cell and a plurality of target cells of the network; receiving, from the network, an indication of how to identify potential handover opportunities between the serving cell and at least one of the plurality of target cells within the first time duration using the at least one metric, the potential handover opportunities comprising respective combinations of a target cell identity and a time instance for executing handover; identifying, for the first time duration commencing at a first time, a first set of potential handover opportunities between the serving cell and at least one of the plurality of target cells within the first time duration using the at least one metric; and signalling an indication of at least one of said first set of potential handover opportunities to the network.

The signalling the indication of at least one of said first set of potential handover opportunities to the network may comprise: signalling an indication of a plurality of said first set of potential handover opportunities to the serving cell; receiving, from the serving cell, an indication of a single potential handover opportunity of the plurality of first set of potential handover opportunities; and performing a handover to the target cell identified by the single potential handover opportunity at the time instance indicated by the single potential handover opportunity.

The identifying may comprise, for each target cell identified by said plurality of handover opportunities, predicting values of the at least one metric at different time instances within said first duration of time to form respective predicted metrics.

The indication of said plurality of first set of potential handover opportunities signalled to the serving cell may comprise, for each target cell identified by said plurality of first set of potential handover opportunities, at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The signalling the indication of at least one of said first set of potential handover opportunities to the network may comprise: signalling an indication of a single potential handover opportunity to the serving cell; and performing a handover to the target cell identified by the single potential handover opportunity at the time instance indicated by the single potential handover opportunity.

Said identifying may comprise: predicting, for each target cell identified by the first set of potential handover opportunities, values of the at least one metric at different time instances within said first duration of time to form respective predicted metrics; and selecting the single potential handover opportunity by selecting the single potential handover opportunity using the predicted metrics.

At least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The method may comprise: abstaining from performing a handover at a first one of the handover opportunities of the first set; and performing a handover to a selected one of the plurality of target cells at a second one of the handover opportunities, the second one of the handover opportunities occurring later in time than the first one of the handover opportunities.

The method may comprise: identifying, for the first time duration commencing at a second time, a second set of potential handover opportunities between the serving cell and at least one of the plurality of target cells within the first time duration using the at least one metric, wherein the second time is later than the first time; and signalling an indication of at least one of said second set of potential handover opportunities to the serving cell.

The at least one metric may comprise a Reference Signal Received Power and/or a Reference Signal Received Quality.

According to a second aspect, there is provided a method for a serving access node providing a serving cell to a user equipment, the method comprising: signalling, to the user equipment, an indication of a first time duration and an indication of at least one metric to be predicted within the first time duration for at least the serving cell and a plurality of target cells; signalling, to the user equipment, an indication of how to identify potential handover opportunities between the serving cell and at least one of the plurality of target cells within the first time duration using the at least one metric, the potential handover opportunities comprising a respective combinations of a target cell identity and a time instance for executing handover; and receiving, from the user equipment, an indication of at least one of a first set of potential handover opportunities for handing the user equipment over from the serving cell to at least one of the plurality of serving cells within the first time duration using the at least one metric.

The receiving the indication of at least one of said first set of potential handover opportunities may comprise: receiving an indication of a single potential handover opportunity; and causing a handover to the target cell identified by the single potential handover opportunity to be performed at the time instance indicated by the single potential handover opportunity.

The receiving the indication of at least one of said first set of potential handover opportunities may comprise: receiving, from the user equipment, an indication of a plurality of said first set of potential handover opportunities; selecting a single potential handover opportunity from said potential handover opportunities by determining that the target cell identified by the single potential handover opportunity can also provide coverage to the user equipment during a time instance associated within another of said first set of potential handover opportunities; and signalling, to the user equipment, an indication of the single potential handover opportunity of the plurality of first set of potential handover opportunities.

Said receiving an indication of at least one of a first set of potential handover opportunities may comprise receiving, for each target cell identified by the first set of potential handover opportunities, values of the at least one metric at different time instances within said first duration of time to form respective predicted metrics; and said selecting the single potential handover opportunity may comprise selecting the single potential handover opportunity using the predicted metrics.

The at least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The method may comprise: causing the user equipment to be handed over to the target cell identified by the single potential handover opportunity at the time instance indicated by the single potential handover opportunity.

The method may comprise: causing a handover to be performed by the user equipment by: abstaining from causing a handover to be performed at a first one of the handover opportunities of the first set; and causing handover to a selected one of the plurality of target cells at a second one of the handover opportunities, the second one of the handover opportunities occurring later in time than the first one of the handover opportunities.

The method may comprise: receiving, from the user equipment, an indication of a second set of potential handover opportunities between the serving cell and at least one of the plurality of target cells within the first time duration, wherein second set of potential handover opportunities relates to a set of predictions made using the metric for the first time duration commencing at a second time, the second time is later than the first time; and causing the user equipment to be handed over to the target cell identified by at least one of the second set of potential handover opportunities at the time instance indicated by one of said second set of potential handover opportunities.

The at least one metric may comprise a Reference Signal Received Power and/or a Reference Signal Received Quality.

According to a third aspect, there is provided an apparatus for a user equipment, the apparatus comprising means for performing: receiving, from a network, an indication of a first time duration and an indication of at least one metric to be predicted within the first time duration for at least a serving cell and a plurality of target cells of the network; receiving, from the network, an indication of how to identify potential handover opportunities between the serving cell and at least one of the plurality of target cells within the first time duration using the at least one metric, the potential handover opportunities comprising respective combinations of a target cell identity and a time instance for executing handover; identifying, for the first time duration commencing at a first time, a first set of potential handover opportunities between the serving cell and at least one of the plurality of target cells within the first time duration using the at least one metric; and signalling an indication of at least one of said first set of potential handover opportunities to the network.

The means for signalling the indication of at least one of said first set of potential handover opportunities to the network may comprise means for: signalling an indication of a plurality of said first set of potential handover opportunities to the serving cell; receiving, from the serving cell, an indication of a single potential handover opportunity of the plurality of first set of potential handover opportunities; and performing a handover to the target cell identified by the single potential handover opportunity at the time instance indicated by the single potential handover opportunity.

The means for identifying may comprise means for, for each target cell identified by said plurality of handover opportunities, predicting values of the at least one metric at different time instances within said first duration of time to form respective predicted metrics.

The indication of said plurality of first set of potential handover opportunities signalled to the serving cell may comprise, for each target cell identified by said plurality of first set of potential handover opportunities, at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The means for signalling the indication of at least one of said first set of potential handover opportunities to the network may comprise means for: signalling an indication of a single potential handover opportunity to the serving cell; and performing a handover to the target cell identified by the single potential handover opportunity at the time instance indicated by the single potential handover opportunity.

Said means for identifying may comprise means for: predicting, for each target cell identified by the first set of potential handover opportunities, values of the at least one metric at different time instances within said first duration of time to form respective predicted metrics; and selecting the single potential handover opportunity by selecting the single potential handover opportunity using the predicted metrics.

At least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may comprise means for performing: abstaining from performing a handover at a first one of the handover opportunities of the first set; and performing a handover to a selected one of the plurality of target cells at a second one of the handover opportunities, the second one of the handover opportunities occurring later in time than the first one of the handover opportunities.

The apparatus may comprise means for performing: identifying, for the first time duration commencing at a second time, a second set of potential handover opportunities between the serving cell and at least one of the plurality of target cells within the first time duration using the at least one metric, wherein the second time is later than the first time; and signalling an indication of at least one of said second set of potential handover opportunities to the serving cell.

The at least one metric may comprise a Reference Signal Received Power and/or a Reference Signal Received Quality.

According to a fourth aspect, there is provided an apparatus for a serving access node providing a serving cell to a user equipment, the apparatus comprising means for performing: signalling, to the user equipment, an indication of a first time duration and an indication of at least one metric to be predicted within the first time duration for at least the serving cell and a plurality of target cells; signalling, to the user equipment, an indication of how to identify potential handover opportunities between the serving cell and at least one of the plurality of target cells within the first time duration using the at least one metric, the potential handover opportunities comprising a respective combinations of a target cell identity and a time instance for executing handover; and receiving, from the user equipment, an indication of at least one of a first set of potential handover opportunities for handing the user equipment over from the serving cell to at least one of the plurality of serving cells within the first time duration using the at least one metric.

The means for receiving the indication of at least one of said first set of potential handover opportunities may comprise means for: receiving an indication of a single potential handover opportunity; and causing a handover to the target cell identified by the single potential handover opportunity to be performed at the time instance indicated by the single potential handover opportunity.

The means for receiving the indication of at least one of said first set of potential handover opportunities may comprise means for: receiving, from the user equipment, an indication of a plurality of said first set of potential handover opportunities; selecting a single potential handover opportunity from said potential handover opportunities by determining that the target cell identified by the single potential handover opportunity can also provide coverage to the user equipment during a time instance associated within another of said first set of potential handover opportunities; and signalling, to the user equipment, an indication of the single potential handover opportunity of the plurality of first set of potential handover opportunities.

Said means for receiving an indication of at least one of a first set of potential handover opportunities may comprise means for receiving, for each target cell identified by the first set of potential handover opportunities, values of the at least one metric at different time instances within said first duration of time to form respective predicted metrics; and said means for selecting the single potential handover opportunity may comprise means for selecting the single potential handover opportunity using the predicted metrics.

The at least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may comprise means for performing: causing the user equipment to be handed over to the target cell identified by the single potential handover opportunity at the time instance indicated by the single potential handover opportunity.

The apparatus may comprise means for performing: causing a handover to be performed by the user equipment by: abstaining from causing a handover to be performed at a first one of the handover opportunities of the first set; and causing handover to a selected one of the plurality of target cells at a second one of the handover opportunities, the second one of the handover opportunities occurring later in time than the first one of the handover opportunities.

The apparatus may comprise means for performing: receiving, from the user equipment, an indication of a second set of potential handover opportunities between the serving cell and at least one of the plurality of target cells within the first time duration, wherein second set of potential handover opportunities relates to a set of predictions made using the metric for the first time duration commencing at a second time, the second time is later than the first time; and causing the user equipment to be handed over to the target cell identified by at least one of the second set of potential handover opportunities at the time instance indicated by one of said second set of potential handover opportunities.

The at least one metric may comprise a Reference Signal Received Power and/or a Reference Signal Received Quality.

According to a fifth aspect, there is provided an apparatus for a user equipment, the apparatus comprising: at least one processor; and at least one memory comprising software code that, when executed by the at least one processor, causes the apparatus to perform: receiving, from a network, an indication of a first time duration and an indication of at least one metric to be predicted within the first time duration for at least a serving cell and a plurality of target cells of the network; receiving, from the network, an indication of how to identify potential handover opportunities between the serving cell and at least one of the plurality of target cells within the first time duration using the at least one metric, the potential handover opportunities comprising respective combinations of a target cell identity and a time instance for executing handover; identifying, for the first time duration commencing at a first time, a first set of potential handover opportunities between the serving cell and at least one of the plurality of target cells within the first time duration using the at least one metric; and signalling an indication of at least one of said first set of potential handover opportunities to the network.

The signalling the indication of at least one of said first set of potential handover opportunities to the network may comprise: signalling an indication of a plurality of said first set of potential handover opportunities to the serving cell; receiving, from the serving cell, an indication of a single potential handover opportunity of the plurality of first set of potential handover opportunities; and performing a handover to the target cell identified by the single potential handover opportunity at the time instance indicated by the single potential handover opportunity.

The identifying may comprise, for each target cell identified by said plurality of handover opportunities, predicting values of the at least one metric at different time instances within said first duration of time to form respective predicted metrics.

The indication of said plurality of first set of potential handover opportunities signalled to the serving cell may comprise, for each target cell identified by said plurality of first set of potential handover opportunities, at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The signalling the indication of at least one of said first set of potential handover opportunities to the network may comprise: signalling an indication of a single potential handover opportunity to the serving cell; and performing a handover to the target cell identified by the single potential handover opportunity at the time instance indicated by the single potential handover opportunity.

Said identifying may comprise: predicting, for each target cell identified by the first set of potential handover opportunities, values of the at least one metric at different time instances within said first duration of time to form respective predicted metrics; and selecting the single potential handover opportunity by selecting the single potential handover opportunity using the predicted metrics.

At least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may be caused to perform: abstaining from performing a handover at a first one of the handover opportunities of the first set; and performing a handover to a selected one of the plurality of target cells at a second one of the handover opportunities, the second one of the handover opportunities occurring later in time than the first one of the handover opportunities.

The apparatus may be caused to perform: identifying, for the first time duration commencing at a second time, a second set of potential handover opportunities between the serving cell and at least one of the plurality of target cells within the first time duration using the at least one metric, wherein the second time is later than the first time; and signalling an indication of at least one of said second set of potential handover opportunities to the serving cell.

The at least one metric may comprise a Reference Signal Received Power and/or a Reference Signal Received Quality.

According to a sixth aspect, there is provided an apparatus for a serving access node providing a serving cell to a user equipment, the apparatus comprising: at least one processor; and at least one memory comprising software code that, when executed by the at least one processor, causes the apparatus to perform: signalling, to the user equipment, an indication of a first time duration and an indication of at least one metric to be predicted within the first time duration for at least the serving cell and a plurality of target cells; signalling, to the user equipment, an indication of how to identify potential handover opportunities between the serving cell and at least one of the plurality of target cells within the first time duration using the at least one metric, the potential handover opportunities comprising a respective combinations of a target cell identity and a time instance for executing handover; and receiving, from the user equipment, an indication of at least one of a first set of potential handover opportunities for handing the user equipment over from the serving cell to at least one of the plurality of serving cells within the first time duration using the at least one metric.

The receiving the indication of at least one of said first set of potential handover opportunities may comprise: receiving an indication of a single potential handover opportunity; and causing a handover to the target cell identified by the single potential handover opportunity to be performed at the time instance indicated by the single potential handover opportunity.

The receiving the indication of at least one of said first set of potential handover opportunities may comprise: receiving, from the user equipment, an indication of a plurality of said first set of potential handover opportunities; selecting a single potential handover opportunity from said potential handover opportunities by determining that the target cell identified by the single potential handover opportunity can also provide coverage to the user equipment during a time instance associated within another of said first set of potential handover opportunities; and signalling, to the user equipment, an indication of the single potential handover opportunity of the plurality of first set of potential handover opportunities.

Said receiving an indication of at least one of a first set of potential handover opportunities may comprise receiving, for each target cell identified by the first set of potential handover opportunities, values of the at least one metric at different time instances within said first duration of time to form respective predicted metrics; and said selecting the single potential handover opportunity may comprise selecting the single potential handover opportunity using the predicted metrics.

The at least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may be caused to perform: causing the user equipment to be handed over to the target cell identified by the single potential handover opportunity at the time instance indicated by the single potential handover opportunity.

The apparatus may be caused to perform: causing a handover to be performed by the user equipment by: abstaining from causing a handover to be performed at a first one of the handover opportunities of the first set; and causing handover to a selected one of the plurality of target cells at a second one of the handover opportunities, the second one of the handover opportunities occurring later in time than the first one of the handover opportunities.

The apparatus may be caused to perform: receiving, from the user equipment, an indication of a second set of potential handover opportunities between the serving cell and at least one of the plurality of target cells within the first time duration, wherein second set of potential handover opportunities relates to a set of predictions made using the metric for the first time duration commencing at a second time, the second time is later than the first time; and causing the user equipment to be handed over to the target cell identified by at least one of the second set of potential handover opportunities at the time instance indicated by one of said second set of potential handover opportunities.

The at least one metric may comprise a Reference Signal Received Power and/or a Reference Signal Received Quality.

According to a seventh aspect, there is provided an apparatus for a user equipment, the apparatus comprising: receiving circuitry for receiving, from a network, an indication of a first time duration and an indication of at least one metric to be predicted within the first time duration for at least a serving cell and a plurality of target cells of the network; receiving circuitry for receiving, from the network, an indication of how to identify potential handover opportunities between the serving cell and at least one of the plurality of target cells within the first time duration using the at least one metric, the potential handover opportunities comprising respective combinations of a target cell identity and a time instance for executing handover; identifying circuitry for identifying, for the first time duration commencing at a first time, a first set of potential handover opportunities between the serving cell and at least one of the plurality of target cells within the first time duration using the at least one metric; and signalling circuitry for signalling an indication of at least one of said first set of potential handover opportunities to the network.

The signalling circuitry for signalling the indication of at least one of said first set of potential handover opportunities to the network may comprise: signalling circuitry for signalling an indication of a plurality of said first set of potential handover opportunities to the serving cell; receiving circuitry for receiving, from the serving cell, an indication of a single potential handover opportunity of the plurality of first set of potential handover opportunities; and performing circuitry for performing a handover to the target cell identified by the single potential handover opportunity at the time instance indicated by the single potential handover opportunity.

The identifying circuitry for identifying may comprise predicting circuitry for, for each target cell identified by said plurality of handover opportunities, predicting values of the at least one metric at different time instances within said first duration of time to form respective predicted metrics.

The indication of said plurality of first set of potential handover opportunities signalled to the serving cell may comprise, for each target cell identified by said plurality of first set of potential handover opportunities, at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The signalling circuitry for signalling the indication of at least one of said first set of potential handover opportunities to the network may comprise: signalling circuitry for signalling an indication of a single potential handover opportunity to the serving cell; and performing circuitry for performing a handover to the target cell identified by the single potential handover opportunity at the time instance indicated by the single potential handover opportunity.

Said identifying circuitry for identifying may comprise: predicting circuitry for predicting, for each target cell identified by the first set of potential handover opportunities, values of the at least one metric at different time instances within said first duration of time to form respective predicted metrics; and selecting circuitry for selecting the single potential handover opportunity by selecting the single potential handover opportunity using the predicted metrics.

At least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may comprise: abstaining circuitry for abstaining from performing a handover at a first one of the handover opportunities of the first set; and performing circuitry for performing a handover to a selected one of the plurality of target cells at a second one of the handover opportunities, the second one of the handover opportunities occurring later in time than the first one of the handover opportunities.

The apparatus may comprise: identifying circuitry for identifying, for the first time duration commencing at a second time, a second set of potential handover opportunities between the serving cell and at least one of the plurality of target cells within the first time duration using the at least one metric, wherein the second time is later than the first time; and signalling circuitry for signalling an indication of at least one of said second set of potential handover opportunities to the serving cell.

The at least one metric may comprise a Reference Signal Received Power and/or a Reference Signal Received Quality.

According to an eighth aspect, there is provided an apparatus for a serving access node providing a serving cell to a user equipment, the apparatus comprising: signalling circuitry for signalling, to the user equipment, an indication of a first time duration and an indication of at least one metric to be predicted within the first time duration for at least the serving cell and a plurality of target cells; signalling circuitry for signalling, to the user equipment, an indication of how to identify potential handover opportunities between the serving cell and at least one of the plurality of target cells within the first time duration using the at least one metric, the potential handover opportunities comprising a respective combinations of a target cell identity and a time instance for executing handover; and receiving circuitry for receiving, from the user equipment, an indication of at least one of a first set of potential handover opportunities for handing the user equipment over from the serving cell to at least one of the plurality of serving cells within the first time duration using the at least one metric.

The receiving circuitry for receiving the indication of at least one of said first set of potential handover opportunities may comprise: receiving circuitry for receiving an indication of a single potential handover opportunity; and causing circuitry for causing a handover to the target cell identified by the single potential handover opportunity to be performed at the time instance indicated by the single potential handover opportunity.

The receiving circuitry for receiving the indication of at least one of said first set of potential handover opportunities may comprise: receiving circuitry for receiving, from the user equipment, an indication of a plurality of said first set of potential handover opportunities; selecting circuitry for selecting a single potential handover opportunity from said potential handover opportunities by determining that the target cell identified by the single potential handover opportunity can also provide coverage to the user equipment during a time instance associated within another of said first set of potential handover opportunities; and signalling circuitry for signalling, to the user equipment, an indication of the single potential handover opportunity of the plurality of first set of potential handover opportunities.

Said receiving circuitry for receiving an indication of at least one of a first set of potential handover opportunities may comprise receiving circuitry for receiving, for each target cell identified by the first set of potential handover opportunities, values of the at least one metric at different time instances within said first duration of time to form respective predicted metrics; and said selecting circuitry for selecting the single potential handover opportunity may comprise selecting circuitry for selecting the single potential handover opportunity using the predicted metrics.

The at least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may comprise: causing circuitry for causing the user equipment to be handed over to the target cell identified by the single potential handover opportunity at the time instance indicated by the single potential handover opportunity.

The apparatus may comprise: causing circuitry for causing a handover to be performed by the user equipment by: abstaining from causing a handover to be performed at a first one of the handover opportunities of the first set; and causing handover to a selected one of the plurality of target cells at a second one of the handover opportunities, the second one of the handover opportunities occurring later in time than the first one of the handover opportunities.

The apparatus may comprise: receiving circuitry for receiving, from the user equipment, an indication of a second set of potential handover opportunities between the serving cell and at least one of the plurality of target cells within the first time duration, wherein second set of potential handover opportunities relates to a set of predictions made using the metric for the first time duration commencing at a second time, the second time is later than the first time; and causing circuitry for causing the user equipment to be handed over to the target cell identified by at least one of the second set of potential handover opportunities at the time instance indicated by one of said second set of potential handover opportunities.

The at least one metric may comprise a Reference Signal Received Power and/or a Reference Signal Received Quality.

According to a ninth aspect, there is provided non-transitory computer readable medium comprising program instructions for causing an apparatus for a user equipment to perform: receiving, from a network, an indication of a first time duration and an indication of at least one metric to be predicted within the first time duration for at least a serving cell and a plurality of target cells of the network; receiving, from the network, an indication of how to identify potential handover opportunities between the serving cell and at least one of the plurality of target cells within the first time duration using the at least one metric, the potential handover opportunities comprising respective combinations of a target cell identity and a time instance for executing handover; identifying, for the first time duration commencing at a first time, a first set of potential handover opportunities between the serving cell and at least one of the plurality of target cells within the first time duration using the at least one metric; and signalling an indication of at least one of said first set of potential handover opportunities to the network.

The signalling the indication of at least one of said first set of potential handover opportunities to the network may comprise: signalling an indication of a plurality of said first set of potential handover opportunities to the serving cell; receiving, from the serving cell, an indication of a single potential handover opportunity of the plurality of first set of potential handover opportunities; and performing a handover to the target cell identified by the single potential handover opportunity at the time instance indicated by the single potential handover opportunity.

The identifying may comprise, for each target cell identified by said plurality of handover opportunities, predicting values of the at least one metric at different time instances within said first duration of time to form respective predicted metrics.

The indication of said plurality of first set of potential handover opportunities signalled to the serving cell may comprise, for each target cell identified by said plurality of first set of potential handover opportunities, at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The signalling the indication of at least one of said first set of potential handover opportunities to the network may comprise: signalling an indication of a single potential handover opportunity to the serving cell; and performing a handover to the target cell identified by the single potential handover opportunity at the time instance indicated by the single potential handover opportunity.

Said identifying may comprise: predicting, for each target cell identified by the first set of potential handover opportunities, values of the at least one metric at different time instances within said first duration of time to form respective predicted metrics; and selecting the single potential handover opportunity by selecting the single potential handover opportunity using the predicted metrics.

At least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may be caused to perform: abstaining from performing a handover at a first one of the handover opportunities of the first set; and performing a handover to a selected one of the plurality of target cells at a second one of the handover opportunities, the second one of the handover opportunities occurring later in time than the first one of the handover opportunities.

The apparatus may be caused to perform: identifying, for the first time duration commencing at a second time, a second set of potential handover opportunities between the serving cell and at least one of the plurality of target cells within the first time duration using the at least one metric, wherein the second time is later than the first time; and signalling an indication of at least one of said second set of potential handover opportunities to the serving cell.

The at least one metric may comprise a Reference Signal Received Power and/or a Reference Signal Received Quality.

According to a tenth aspect, there is provided non-transitory computer readable medium comprising program instructions for causing an apparatus for a serving access node providing a serving cell to a user equipment to perform: signalling, to the user equipment, an indication of a first time duration and an indication of at least one metric to be predicted within the first time duration for at least the serving cell and a plurality of target cells; signalling, to the user equipment, an indication of how to identify potential handover opportunities between the serving cell and at least one of the plurality of target cells within the first time duration using the at least one metric, the potential handover opportunities comprising a respective combinations of a target cell identity and a time instance for executing handover; and receiving, from the user equipment, an indication of at least one of a first set of potential handover opportunities for handing the user equipment over from the serving cell to at least one of the plurality of serving cells within the first time duration using the at least one metric.

The receiving the indication of at least one of said first set of potential handover opportunities may comprise: receiving an indication of a single potential handover opportunity; and causing a handover to the target cell identified by the single potential handover opportunity to be performed at the time instance indicated by the single potential handover opportunity.

The receiving the indication of at least one of said first set of potential handover opportunities may comprise: receiving, from the user equipment, an indication of a plurality of said first set of potential handover opportunities; selecting a single potential handover opportunity from said potential handover opportunities by determining that the target cell identified by the single potential handover opportunity can also provide coverage to the user equipment during a time instance associated within another of said first set of potential handover opportunities; and signalling, to the user equipment, an indication of the single potential handover opportunity of the plurality of first set of potential handover opportunities.

Said receiving an indication of at least one of a first set of potential handover opportunities may comprise receiving, for each target cell identified by the first set of potential handover opportunities, values of the at least one metric at different time instances within said first duration of time to form respective predicted metrics; and said selecting the single potential handover opportunity may comprise selecting the single potential handover opportunity using the predicted metrics.

The at least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The apparatus may be caused to perform: causing the user equipment to be handed over to the target cell identified by the single potential handover opportunity at the time instance indicated by the single potential handover opportunity.

The apparatus may be caused to perform: causing a handover to be performed by the user equipment by: abstaining from causing a handover to be performed at a first one of the handover opportunities of the first set; and causing handover to a selected one of the plurality of target cells at a second one of the handover opportunities, the second one of the handover opportunities occurring later in time than the first one of the handover opportunities.

The apparatus may be caused to perform: receiving, from the user equipment, an indication of a second set of potential handover opportunities between the serving cell and at least one of the plurality of target cells within the first time duration, wherein second set of potential handover opportunities relates to a set of predictions made using the metric for the first time duration commencing at a second time, the second time is later than the first time; and causing the user equipment to be handed over to the target cell identified by at least one of the second set of potential handover opportunities at the time instance indicated by one of said second set of potential handover opportunities.

The at least one metric may comprise a Reference Signal Received Power and/or a Reference Signal Received Quality.

According to an eleventh aspect, there is provided a computer program product stored on a medium that may cause an apparatus to perform any method as described herein.

According to a twelfth aspect, there is provided an electronic device that may comprise apparatus as described herein.

According to a thirteenth aspect, there is provided a chipset that may comprise an apparatus as described herein.

### BRIEF DESCRIPTION OF FIGURES

Some examples, will now be described, merely by way of illustration only, with reference to the accompanying drawings in which:

FIG. 1 shows a schematic representation of a 5G system;

FIG. 2 shows a schematic representation of a network apparatus;

FIG. 3 shows a schematic representation of a user equipment;

FIG. 4 illustrates signalling operations;

FIG. 5 illustrates a measurement configuration;

FIGS. 6 to 7 illustrate example handover occasions;

FIG. 8 illustrates example signalling operations;

FIGS. 9A to 10 illustrate example handover occasions; and

FIGS. 11 to 12 illustrate example operations that may be performed by apparatus mentioned herein.

### DETAILED DESCRIPTION

The following describes operations that may be performed more efficiently performing handovers in a radio access network.

In the following description of examples, certain aspects are explained with reference to devices that are often capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals, IEEE 802.11, etc.).

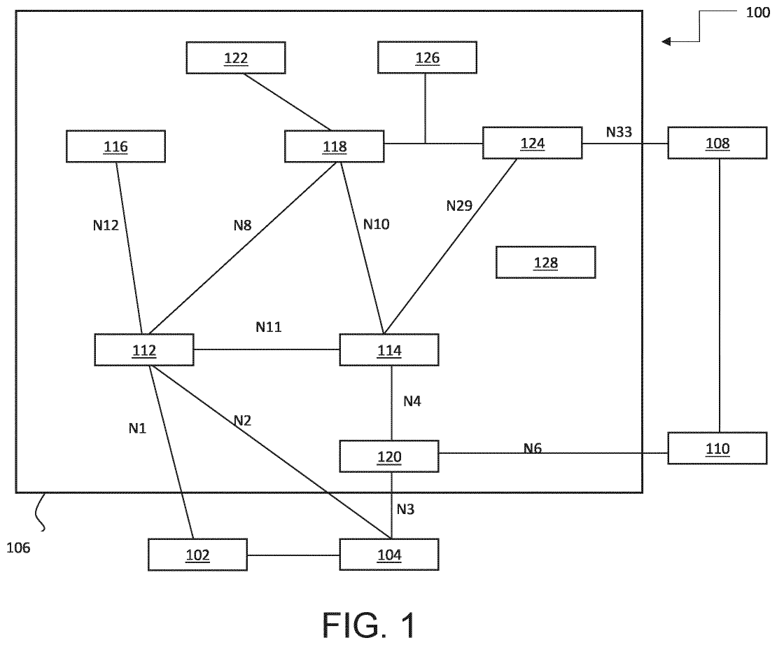

Before describing in detail the examples, certain general principles of a 5G wireless communication system are briefly explained with reference to FIGS. 1 to 3.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

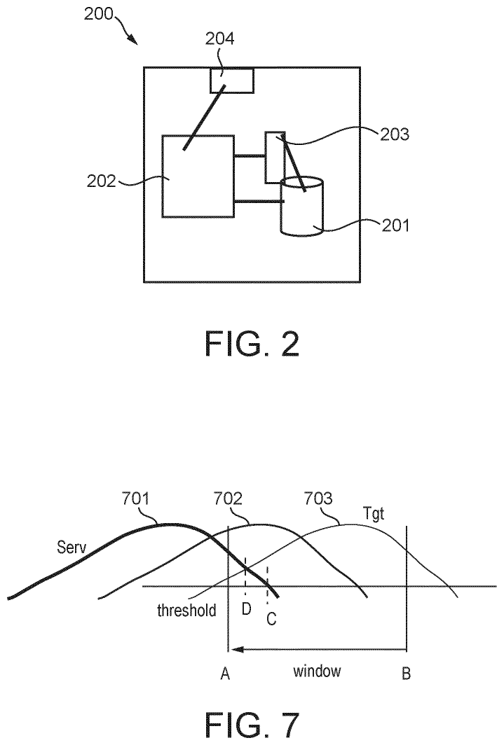

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

The station of the access system may be categorised into two different types: distributed units (DUs), and centralised units (CUs).

A DU provides access node support for lower layers of the protocol stack (such as, for example, the radio link control (RLC), medium access control (MAC), and/or physical layer protocol layers). Each DU is able to support one or more cells, while each cell is able to support one or more beams.

A CU can support multiple DUs, and provides access node support for higher layers of the protocol stack within an access node (such as, for example, packet data convergence protocol (PDCP), service data adaptation protocol (SDAP), and/or radio resource control (RRC) protocol layers). The interface between a CU and a DU is labelled as an F1 interface. There is a single CU for each gNB, and CU's belonging to multiple gNB may be implemented using a shared hardware platform.

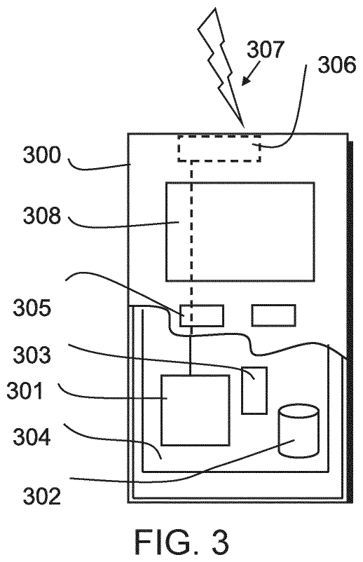

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

The following description also provides illustrative examples with reference to Primary Secondary Cells (PSCells), Primary Cells (PCells), and Secondary Cells (SCells). The following will outline features of PSCells in relation to 5G New Radio, using terminology used therein. However, it is understood that the presently described principles are not limited to such terminology, and may be applied to other systems having a similar architecture. For example, in multi-radio-dual connectivity (MR-DC), a Primary Cell (PCell) may be a Long Term Evolution (LTE) cell (e.g., Evolved-Universal Terrestrial Radio Access-New Radio-dual connectivity (EN-DC)).

PSCells are a type of cell currently defined in 5G New Radio, along with Primary Cells (PCells), Secondary Cells (SCells) and Special Cells (SpCells). A PCell may be used as part of an initial access between a UE and an access network, and is considered to be a main cell in a master cell group (MCG). A PSCell may be comprised as part of a secondary cell group (SCG). The SpCells and SCells may be in at least one of the MCG and the SCG.

The cells may be controlled by network nodes. There are a maximum of two different types of network nodes in 5G New Radio: Master nodes (which provide a control plane connection to a core network); and Secondary Nodes (which do not have control plane connections to the core network). It is understood that not all 5G system deployments may comprise a master node and secondary node. For example, the Master and Secondary nodes may be present in a master node-dual connectivity deployment, but not in a standalone deployment. The Master and Secondary nodes may both provide user plane (e.g. data) connections to the core network. The Master node may control the PCell. In addition to the PCell, the Master node may control at least one PSCell, although this is not always the case. The Secondary node may control at least one PSCell.

3GPP has issued a number of releases (Rel) for defining operating communication protocols related to a communications network. Currently, objectives and work are being set in relation to Release 18 (Rel. 18).

Conditional mobility was introduced in 3GPP Rel-16 to improve mobility robustness. Conditional mobility relates to providing a UE with at least one configuration to use for communicating with another cell after handover to that cell is performed, along with at least one threshold or condition for determining when to perform handover.

Therefore, as a part of this conditional mobility functionality, the network can prepare multiple target cells and provide UE with a conditional mobility configuration associated with mobility execution condition. The decision on mobility execution is therefore left to the UE, which is obliged to follow the conditional mobility configuration that defines how and when to execute a mobility event. The conditional mobility configuration may be provided to the UE by a source cell (e.g., by the current serving cell of the UE). The conditional mobility configuration may be prepared by source cell in co-operation with at least one target cell(s).

Conditional mobility preparation (e.g., the source cell communicating with the at least one target cell to obtain a conditional mobility configuration to provide to a UE) may be triggered by mobility-related measurement events received by the source cell. For example, in current 3GPP specifications, these measurement events may be A3/A5 measurement events in case of handover. Whenever a configured execution condition(s) is met for some target cell (the process for determining which being called an “evaluation phase”), the UE selects a corresponding target configuration and performs a mobility procedure to enable provision of services via the selected target cell. The performance of the mobility procedure is also referred to as an “execution phase”.

There are several types of conditional mobility event. Of these, conditional handover (CHO), conditional Primary-Secondary Cell (PSCell) Addition (CPA) and conditional PSCell Change (CPC) are mentioned below. The signalling procedure for performing conditional handover is described in section 9.2.3.4.2 of TS 38.300.

Mobility management is another scheme related to mobility operations. Mobility management is a scheme for guaranteeing service-continuity during mobility operations (e.g., cell change, cell addition, handover, etc.). This may involve minimizing: call drops, radio link failures (RLFs), unnecessary handovers, and ping-ponging between accesses provided by different cells. In addition, for the applications characterized with stringent Quality of Service (QOS) requirements (e.g., reliability, latency etc.), the Quality of Experience (QoE) is sensitive to the handover performance, so mobility management attempts to avoid unsuccessful handover and reduce the latency during handover procedure.

To address at least part of this, there is provided a study on enhancement for data collection for new radio (NR) and enhanced dual connectivity (EN-DC) having general objectives to study the high level principles for the enablement of A1 in a radio access network (RAN) and the functional framework (including the A1 functionality and the inputs and outputs) for enabling deployment of an ML algorithm at the RAN-level. In one use case defined in 3GPP TR 37.817 section 5.3, “Mobility Optimization” aims to increase the mobility performance of UEs by the use of A1/ML solutions.

In more detail, Rel-18 has commissioned a study on Artificial Intelligence (A1)/Machine Learning (ML) for NR Air Interface. There are a plurality of objectives for this study.

For example, a number of potential use cases (such as those mentioned below) have been identified, and one objective of the study is to consider the 3GPP framework for A1/ML for air-interface corresponding to each use case regarding aspects such as performance, complexity, and potential specification impact.

Use cases to focus on include an initial set of use cases relating to:
Channel State Indicator feedback enhancements (e.g., overhead reduction, improved accuracy, prediction, etc.)
Beam management, e.g., beam prediction in time, and/or spatial domain for overhead and latency reduction, beam selection accuracy improvement
Positioning accuracy enhancements for different scenarios including, e.g., those with heavy NLOS conditions and a later set of use cases comprising representative sub use cases for each use case for characterization and baseline performance evaluations. The AI/ML approaches for the representative sub use cases may be diverse enough to support various requirements on the gNB-UE collaboration levels.

Another objective of this study is to define AI/ML model(s) to be used, including terminology and description to identify common and specific characteristics for framework investigations.

This may comprise a characterizing stage (in which stages of AI/ML related algorithms and associated complexity are defined), and a collaboration stage (in which various degrees of collaboration between a UE and an access node for various use cases are identified).

The characterizing stage may comprise both model generation (e.g., model training (including input/output, pre-/post-process, online/offline as applicable), model validation, model testing, etc.), and an inference operation (e.g., input/output, pre-/post-processing, etc.).

The collaboration stage may identify various levels of collaboration between a UE and an access node that are pertinent to the selected use cases. For example, when there is no collaboration between the UE and an access node for a selected use case, there may be provided implementation-based only AI/ML algorithms without information exchange. In contrast, when there are various levels of UE-access point collaboration, there may be provided separate or joint ML operation.

Other factors relating to AI/ML models and algorithms may also be considered.

For example, a lifecycle management of an A1/ML model may be characterized (e.g., model training, model deployment, model inference, model monitoring, model updating, etc.).

As another factor, dataset(s) used for training, validation, testing, and inference may be considered.

As another factor, common notation and terminology for AI/ML related functions, procedures and interfaces may be identified.

For the use cases under consideration within this study, the potential impact of the 3GPP specifications may be considered with the aim of establishing a common framework. This may be looked at from both the perspective of the physical (PHY) layer, and from the perspective of higher layer protocols.

The physical layer aspects may be looked at in relation to, for example, the potential specification of the A1 Model lifecycle management, and dataset construction for training, validation and test for the selected use cases. Further, both use case and collaboration level-specific impact on the 3GPP specifications may be considered impact, such as new signalling, functions for training and validation data assistance, the provision of assistance information, measurement definitions, and feedback operations.

The protocol aspects may consider aspects related to, e.g., capability indications, configuration and control procedures (training/inference), management of data and AI/ML model, and collaboration-level specific specification impact per use case.

As part of above mentioned efforts, models have been discussed in 3GPP that perform prediction of beam Reference Signal Received Power (RSRP) and beam identifiers in the time domain.

Some mechanisms that are used for initiating handover related procedures, whether it be network-initiated/instructed or a conditional mobility event are now considered.

In any telecom technology (2G, 3G, 4G or 5G), mobility/handover decision whether mobile device will be handover or not may be performed by an access point based on measurement reports received from the UE. There are multiple measurement metrics (e.g., Reference Signal Received Power (RSRP), Reference Signal Received Quality (RSRQ), Signal to Interference and Noise Ratio (SINR)), multiple times (e.g., periodic, event triggered, etc.) and multiple ways in which a UE may measure a signal quality of the UE's serving cell and neighbor cells. For example, an access node may determine, from the measurement report(s) that the UE is to be handed over from a current serving cell to a target cell that can provide better service to the UE than the serving cell, and signal an instruction to the UE to perform that handover. As another example, an access node may determine that the UE is likely to handover in the near future. The access node may subsequently provide the UE with some monitoring and execution conditions for determining when the UE is to handover to at least one of a plurality of target cells as part of a conditional mobility event.

In an ideal case, an access point allows a UE to report serving cell and neighbor cell signal quality and triggers the UE to perform handover on the basis of a single measurement. In practice however, this can create overload conditions due to unnecessary handovers such as ping pongs.

To minimize the likelihood of such situations, 3GPP specifications have proposed a set of predefined set of measurement report mechanisms to be performed by the UE. The predefined measurement report type is called an “Event”. The type of “event” a UE is configured to report is specified by a Radio Resource Control (RRC) signaling message sent by the access point to the UE.

3GPP TS 38.331 specified following event types for 5G NR:
Event A1 (Serving cell becomes better than a threshold value)
Event A2 (Serving cell becomes worse than a threshold value)
Event A3 (Neighbor cell becomes better than SpCell by more than an offset value).
Event A4 (Neighbor cell becomes better than a threshold value)
Event A5 (SpCell becomes worse than a first threshold (threshold1) and a neighbor cell becomes better than a second threshold (threshold2))

In mobility situations, it may happen that a UE is handed over from a first cell to a second cell only to be handed back to the first cell after a short time. As another example, a UE may be handed over to a third cell a short time after being handed over to the second cell. The handover process usually involves an interruption time, which originates from the time taken by the UE to synchronize to the new cell, and to process any RRC reconfiguration messages. Also, handovers are associated with signaling between the UE and the network, and signaling among nodes within the network, as well as processing tasks in the network.

In addition to existing mobility procedures, recent 3GPP studies have considered layer 1/layer 2 (L1/L2)-triggered mobility (LTM) procedures. Layer 1 refers to a physical layer. Layer 2 refers to a media access control (MAC) layer. LTM is one of the objectives for upcoming mobility enhancement in Rel. 18. LTM introduces new techniques that lowers the handover interruption times, but also may increase handover count compared to BHO.

In contrast to layer 3 (L3) mobility procedures (e.g., network-triggered mobility procedures), in which the handover between two cells is decided by a radio resource control (RRC) layer, LTM is performed by the MAC layer. As such it is terminated in a Distributed Unit (DU) in the CU-DU model of a gNB.

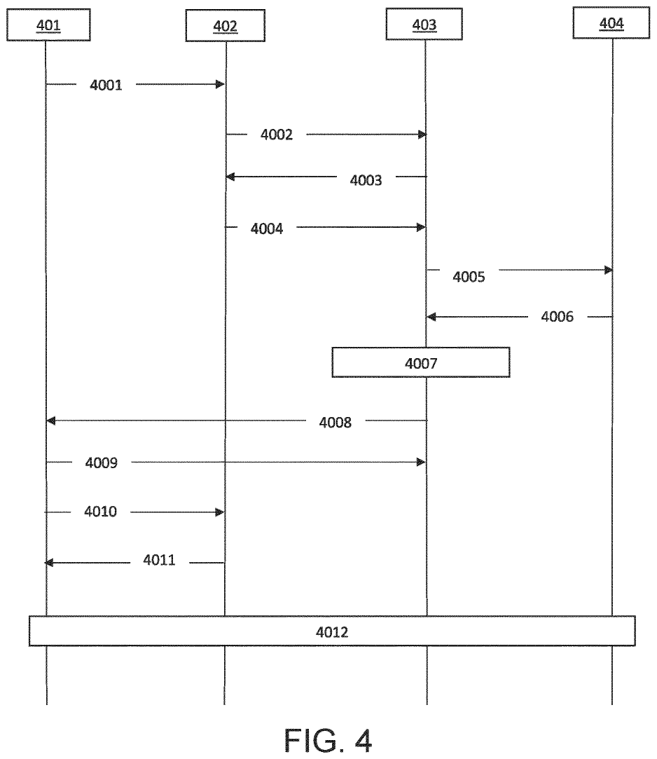

FIG. 4 illustrates example signalling that may be performed in relation of LTM from a serving cell in a first distributed unit (DU1) to a target cell in a second distributed unit (DU2). This scenario is referred to as an inter-DU-intra-CU scenario. An analogous signalling diagram applies for intra-DU-intra-CU cell changes, in which DU1 is the same distributed unit as DU2.

FIG. 4 illustrates signalling that may be performed by a UE 401, a first DU 402, a CU 403, and a second DU 404.

4001 to 4009 refer to a “preparation stage” of the LTM. During a preparation stage, the network decides to configure potential target cells for LRM based on a measurement report received from the UE.

During 4001, the UE 401 signals the first DU 402. This signalling may comprise a measurement report. The measurement report may comprise information specified in a measurement reporting configuration. The measurement report may comprise an indication of measurements made of the UE's radio environment that indicate a state of that radio environment. The report may have been triggered because a signal provided by a neighbour cell may have become better than a signal provided by the serving cell, indicating that the UE is in the cell border area.

The way measurements, measurement triggers, and measurement reporting is set up for RRC is explained in 3GPP TS 38.331 section 5.5.1.

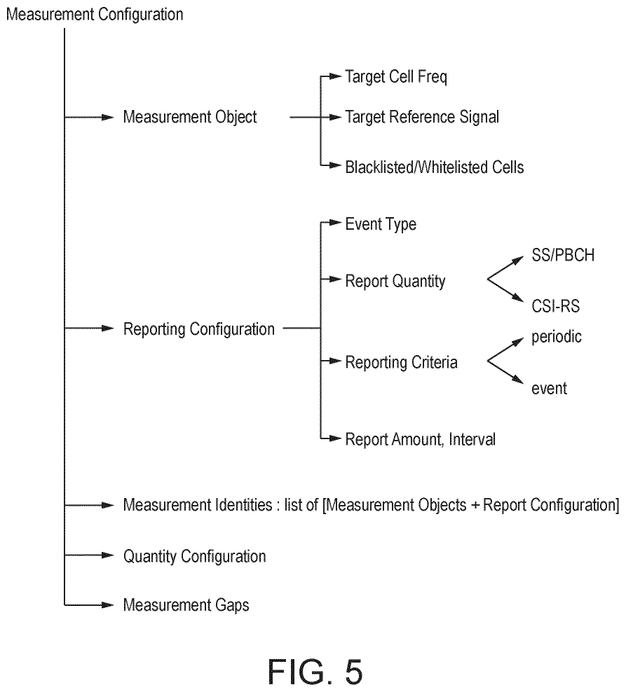

A graphical overview of the hierarchy of configurations is illustrated with respect to FIG. 5.

FIG. 5 illustrates that a measurement configuration is comprised of a measurement object, a reporting configuration, measurement identifies (which comprises a list of combinations of measurement objects and reporting configurations), a quantity configuration (which specifies measurement quantities and layer 3 filtering coefficients), and an indication of at least one measurement gap.

Each measurement object may comprise a target cell frequency, a target reference signal, a list of blacklisted cells and/or whitelisted cells.

Each reporting configuration may comprise an event type, a report quantity (e.g., synchronization signal (SS), a physical broadcast channel (PBCH), and/or a channel state information-reference signal), a reporting criteria (e.g., periodic or event-based), and a report amount, including any interval.

During 4002, the first DU 402 forwards the measurement report received during 4001 to the CU 403.

During 4003, the CU 403 signals the first DU 402. This signalling may comprise a UE context setup request. A purpose of this UE context setup request is to cause a UE context (e.g., security keys, UE capabilities, etc.) to be established at the first DU 402 in respect of the UE.

During 4004, the first DU 402 signals the CU 403. This signalling may comprise a UE context setup response. This signalling may comprise a DU to CU container for communicating between a DU and a CU.

During 4005, the CU 403 signals the second DU 404. This signalling may comprise a UE context setup request. A purpose of this UE context setup request is to cause a UE context to be established at the second DU 404 in respect of the UE.

During 4006, the second DU 404 signals the CU 403. This signalling may comprise a UE context setup response. This signalling may comprise a DU to CU container.

During 4007, the CU 403 generates a radio resource control (RRC) reconfiguration for the UE 401. This RRC reconfiguration may comprise a measurement reporting configuration for layer 1 cell change operations, and configurations of any prepared target cells on which those measurements are to be performed. This generation may be based on the UE context setup responses received during 4004 and 4006.

During 4008, the CU 403 signals the UE 401. This signalling may comprise the RRC reconfiguration generated during 4007.

During 4009, the UE 401 signals the CU 403 to indicate that the UE will apply the RRC reconfiguration received during 4008.

During 4010, the UE 401 signals the first DU 402. This signalling may comprise a measurement report that was generated in accordance with the RRC reconfiguration received during 4008. 4010 may be performed repeatedly (e.g., when the RRC reconfiguration configures the UE 401 to make periodic measurement reports).

During 4011, and based on at least one measurement report received during 4010, the first DU 402 determines that there is a target candidate cell having a better radio link beam measurement than the UE's current serving cell (e.g., L1-RSRP of target beam measurement>L1-RSRP of serving beam measurement+Offset for e.g., Time-to-Trigger (TTT) time), and signals a MAC Control Element (MAC CE) or a L1 message to the UE 401. This signalling to the UE functions as a trigger to cause the UE 401 to implement a cell change operation to the target candidate cell.

During 4012, a handover is performed such that the UE 401 is handed over from a current serving cell provided by the first DU 402 to a target cell.

A primary benefit of LTM compared to baseline handover and conditional handover is that the interruption during the handover execution can be reduced substantially as the UE does not need to perform higher layer reconfiguration (e.g., RRC reconfiguration, and/or packet data convergence protocol (PDCP) reconfiguration). Moreover, for some scenarios, the UE can perform a more generalised handover scheme (known as Random Access Channel (RACH)-less) to connect the target cell than would otherwise be used.

In Frequency Range 2 (FR2), which is a frequency range defined by 3GPP to occupy part of the frequency spectrum above 6 GHz, the channel conditions may change more rapidly compared to Frequency Range 1 (FR1), which is also a frequency range defined by 3GPP. This can lead to more frequent handover for UE operating in FR2 than those operating in FR2. More frequent handovers are associated with an increase in unnecessary handover.

Therefore, if a handover can be avoided, it would lead to less interruption and savings in signaling and processing in the network.

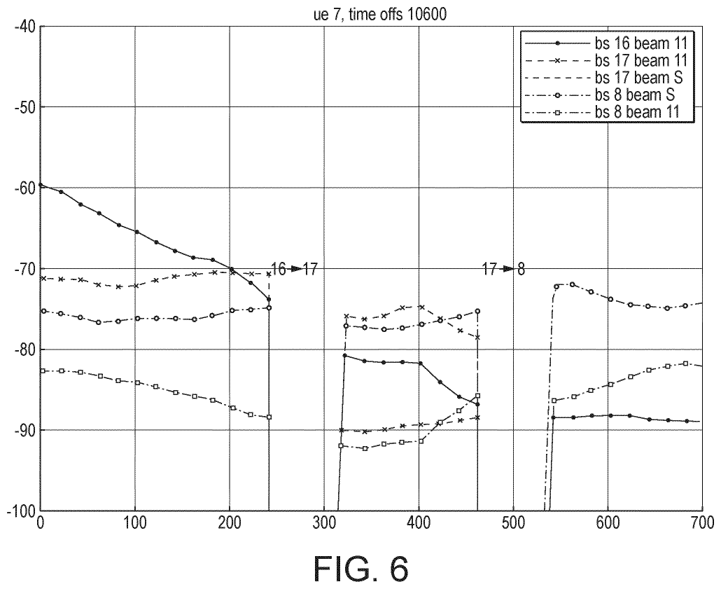

FIG. 6 illustrates the problem of having unnecessary handover that leads to unnecessary gaps with RSRP traces collected from an LTM mobility simulation. The x-axis in this figure corresponds to time, and the y-axis to cell strength. The cell strength may be, for instance, measured as RSRP.

The simulation scenario illustrated by FIG. 6 comprised a UE moving at speed 120 km/h, and a carrier frequency of 30 GHz. Handovers were initiated when it is determined that the quality of a neighbour beam received at the UE becomes better than the UE's serving beam by at least 3 dB.

In FIG. 6, RSRP traces for beam identifiers of 3 cells as recorded at a serving base station in a system-level-simulator. The gaps in the traces indicate where handover happened, and measurements could not be collected. FIG. 7 illustrates that two handover happen within 400 msec. therefore, it appears that at least the first handover could have been avoided.

It would be useful to enable a radio access network entity to anticipate and avoid unnecessary handover where “unnecessary” is parameterized by the network.

To address at least one of the above-mentioned issues, the following proposes mechanisms for reducing the likelihood of an unnecessary handover being performed.

In particular, the following focuses on configuring a UE with a prediction window (e.g., with a duration of time) within which the UE may perform handover from a source access node to multiple target access nodes. The UE is provided with a so-called “viability configuration” (also referred to as a “viability condition” herein) that can be used to identify these multiple handover times. The viability configuration may additionally (in some examples) be able to be used by the UE to identify which of these multiple handovers can be unnecessary, and so may therefore not be performed. In other words, the viability configuration may comprise at least one condition (or set of conditions) that identifies those multiple future handover occasions within the prediction window, and/or that can be used for determining which of those handovers can be deemed unnecessary.

The network may provide different indicators of the duration of time, eg., an exact number of a time unit, or indicate that the UE may select and optionally determine a duration of time or may indicate to the UE to select and optionally determine a duration of time of at least a minimum duration.

In another embodiment the duration of time of the prediction window is determined by the UE. E.g. for 120 km/h in a FR2 setting a sensible duration may be found to be 400 msec.

In another embodiment the network configures a minimal duration.

In some examples, the viability configuration extracts relevant parameters for detecting an unnecessary future handover, but leaves it to a serving access node to perform the final evaluation of which handovers are unnecessary.

The UE performs a prediction of conditions and events that are described by viability configuration provided to the UE by the network. It is left to UE implementation how to arrive at the prediction of conditions and events or key markers described by the viability configuration.

In one example, the UE may predict a window of RSRPs, and derive the outcomes based on that RSRP window. This is referred to in the following in relation to making a RSRP window prediction from which key markers (e.g., events, etc.) are derived.

The viability configuration/condition may comprise at least one of:
1. a minimum connectivity condition of the serving cell, which may be expressed as an absolute threshold, or as an offset to a neighbour cell. A connectivity condition for a cell may be a condition (e.g., a criterion or set of criteria) that is to be met in order for the cell to be considered strong enough for a UE to connect to it.
2. a rule for the UE to select a target cell. For example, the target cell to be selected may be the cell that is predicted to have the longest period of connectivity right after serving cell no longer satisfies minimal connectivity. This is illustrated below in relation to FIG. 7. FIG. 7 illustrates a window spanning time duration A-B along the x-axis and a power and/or quality of a signal received by a user equipment is represented by the y-axis. In FIG. 7, a threshold is represented by a flat line, the current serving cell is represented by a first curve 701, a potential target cell is represented by a second curve 702, and a second potential target cell is represented by a third curve 703. The x-axis represents time. In FIG. 7, the serving cell 701 is considered as not providing the minimal connectivity after point C, when it falls below the threshold. Between time instances C and B, the second potential cell 703 is determined to provide longest connectivity to the UE. Other rules may take into account when making the selection and/or prediction, including relative strengths between possible targets. The points at which the signal strength and/or quality of one cell switches from being lower than another cell to higher than another cell (or vice versa) are known as events. The events may be, for example, A1 events and/or A3 events.

The information (e.g., signal strength and/or signal quality predictions) represented in FIG. 7 may have been obtained by the UE in at least one of a plurality of different ways. For example, the UE may use current signal strength information and mobility information related to how the user equipment is moving relative to the access node(s) providing the cell(s) to predict how the current signal strength is likely to change over time (e.g., within the duration A-B). Further, the UE may use historical signal strength information to predict how the current signal strength is likely to change over time.

The UE may perform computations to obtain these predictions itself, or the UE may outsource these computations to another entity (e.g., a cloud-based server). The predictions may be made using machine learning and/or artificial learning algorithms. In such a case, and when the UE itself performs these predictions, the UE may obtain a trained model on which to perform these predictions. The UE may partially train such a model using measurement information obtained locally to the UE.

The time instance at which the predictions start (e.g., at time A) and/or the duration of the prediction window may be requested dynamically by the network. The time A-B may represent a duration of time that has not yet occurred. In other words, the prediction window spanning may relate to a future time. Time A may represent a current time, or a future time.
3. a rule to select target handover time instance. As predictions may be jittery, the execution of a condition may be defined to occur at a specific time. For example, as abs (predicted time—current time)<eps, where eps can be the measurement interval.

In one embodiment the network configures a minimal duration in which predictions are needed (not shown) and provides the indicator to the UE. If the UE cannot carry out predictions for the indicated duration received from the network, e.g. because its computational strength is not big enough, the UE may choose not to predict or deliver predictions. Otherwise, the UE may determine a duration A-B in which it carries out prediction. The UE may determine a duration A-B as indicated by the network. The UE may determine a duration A-B satisfying the minimal duration indicated by the network.

In one embodiment, the UE determines the duration A-B, e.g. based on its geographical speed. E.g. for 120 km/h in a FR2 setting a sensible duration may be found to be 400 msec.

The above configuration rules may identify when potential handover events may occur by reusing parameterization of existing trigger conditions (e.g., A1, A3, etc. event conditions that are currently defined in 3GPP specifications), including any combination of those trigger conditions.

For example, existing trigger conditions for triggering a handover event (such as, for example, A3 event trigger conditions) may be used when comparing the serving to a neighbour cell strength. Here the configuration rules for an A3-based handover event may be used to compare a hypothetical future serving (e.g., a candidate and/or target cell) to its neighbour cell strength.

In more detail, an A3 event comprises a handover event that is triggered when a neighbouring cell becomes better than a UE's current serving cell by an offset amount, where the offset may be positive or negative. In other words, an A3 event-based handover is triggered when a predetermined set of conditions is fulfilled. The above configuration rules may determine a time when it is predicted that that predetermined set of conditions is fulfilled, and identify that time as a potential future handover instance within the prediction window. The UE may apply the same predetermined set of conditions for predicting events happening between multiple cells within the prediction window, including between two neighbouring cells, and/or between the serving cell and a neighbouring cell. The cells that are evaluated within this prediction window may be limited in some way. For example, the cells may be limited to the serving cell and neighbouring cells to the serving cell. The cells that are evaluated within the prediction window may be determined by the UE. The cells that are evaluated within the prediction window may be determined by the serving cell and signalled to the UE.

Once the UE has determined key outcomes in the prediction window, such as potential future handover instances, the UE will inform the network of the UE's determinations via a report. The network may use the report to prepare the selected target cell at the network to that it is available to the UE at the selected time instance.

As time progresses and the window prediction is updated, the target time as well as target cell may change. The UE may inform the network (e.g., the UE's serving cell) of any changes.

The serving cell may signal the UE to perform handover, when the target time for the handover arrives.

These principles will be illustrated with reference to the following examples.

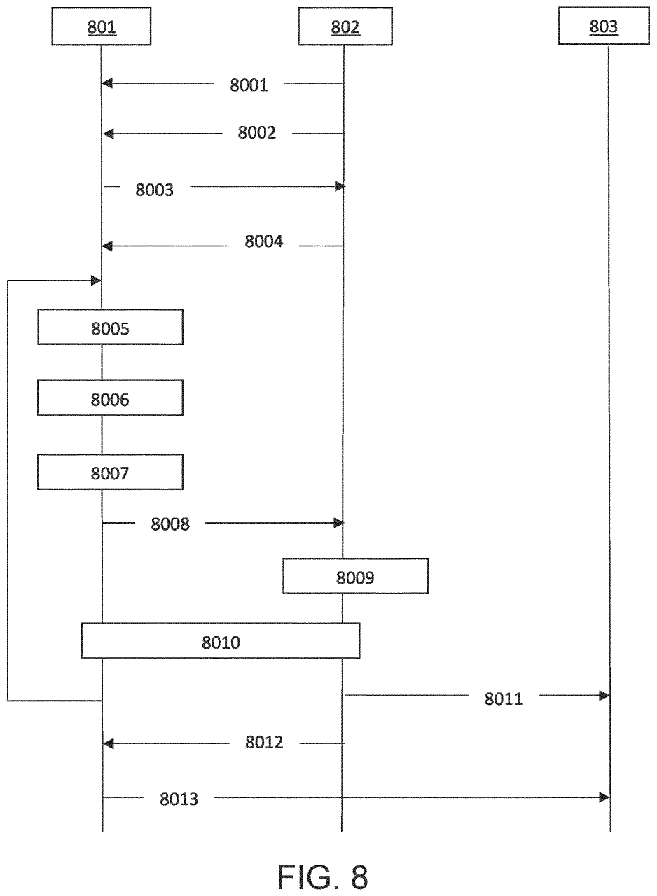

FIG. 8 illustrates signalling that may be performed between a UE 801, a serving access node 802, and a target access node 803.

During 8001, the serving access node 802 (which provides a serving cell to the UE) signals the UE 801.

This signalling of 8001 may configure the UE 801 with a prediction window length. The prediction window length may be set by the serving access node 802 based on, for example, past measured time that a UE stays in a cell. The prediction window length may be set by the serving access node 802 based on system level simulations performed by the network. The serving access node 802 may select a fixed and/or preconfigured value of the prediction window length (e.g., a fixed value of 500 msec). Any fixed and/or preset This value may represent a window duration that is sufficient to identify a potential unnecessary handover for a fast-moving UE.

This signalling of 8001 may configure the UE with at least one parameter for making a prediction within a window of time (which is simply referred to throughout as a “window”). For example, the signalling may comprise a minimum window prediction length, and/or a metric to be predicted within that window. The serving access node 802 may, for example, configure the UE to predict an RSRP of beams within the window length.

During 8002, the serving access node 802 signals the UE 801. This signalling may configure the UE with at least one rule for extracting an action from the window. For example, the signalling of 8002 may comprise the viability configuration. In other words, the signalling of 8002 may indicate to the UE what information is to be extracted from predictions made of received beam properties within the prediction window. For example, the viability configuration may instruct the UE to determine respective time instances at which a receive beam power and/or quality of a specific cell (e.g., a serving cell and/or a target cell) falls above and/or below a predetermined threshold, and/or falls above or below a receive beam power of another cell.

The viability configuration may comprise at least one of a plurality of different rules for the UE to apply in relation to the window.

As a first example, the viability configuration may comprise a combination of existing (legacy) mobility triggers and rules how to derive a target cell. For example, the UE may be configured to use at least one of an A1 event (when the signal received from a cell becomes better than a threshold) and/or an A2 event (when the signal received from a cell becomes worse than a threshold) to mark every cell's viability. A target cell is then selected that is determined to have the longest viability for use after a current serving no longer is viable for use by a UE. A3 thresholds between a serving cell and a target cell may also be used during a prediction window to determine handover time instance.

In this example, the A1, A2, and/or A3 threshold in the prediction interval may compare not only the received signal level of a serving cell to a threshold, but also a received signal level target candidates to a threshold or other neighboring cell candidates.

For instance, the A3 event definition in TS 38.331 5.5.4.4 comprises various parameters for the entering condition

Mn+Ofn+Ocn-Hys>Mp+Ofp+Ocp+Off, where:
Mn is the measurement result of the neighbouring cell, not taking into account any offsets.
Ofn is the measurement object specific offset of the reference signal of the neighbour cell (e.g., offsetMO as defined within measObjectNR corresponding to the neighbour cell).
Ocn is the cell specific offset of the neighbour cell (e.g., cellIndividualOffset as defined within measObjectNR corresponding to the frequency of the neighbour cell), and set to zero if not configured for the neighbour cell.
Mp is the measurement result of the SpCell, not taking into account any offsets.
Ofp is the measurement object specific offset of the SpCell (e.g., offsetMO as defined within measObjectNR corresponding to the SpCell).
Ocp is the cell specific offset of the SpCell (e.g., cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (e.g., a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.

The variables on the left side refer to parameters of the neighbor cell and the variables on the right side (Mp Ofp Ocp) refer to the serving cell (SpCell) and to a configured A3 offset (Off). The reuse of the parameters of this event for the purpose of an A3-prediction event would mean that Mp, Ofp, Ocp refer to the predicted values of a potential future serving cell. There may be more than of possible future serving cell, so these parameters would be applied to all possible candidates.

As a second example, the viability configuration may comprise a minimum connectivity condition of the serving cell, which may be expressed as an absolute threshold, or as an offset to neighbour cell. The viability condition may reuse parameterization of existing trigger conditions (e.g., trigger conditions associated with different events, such as A2 events, A3 events, etc.), and may combine them. For example, the existing trigger A2 (“serving becomes worse than threshold”) definition can be applied to the prediction window, where the cells are (strictly speaking) only hypothetically serving (e.g., the prediction window considers what would happen if handover had occurred from the serving cell to a neighbouring cell at some point within the prediction window).

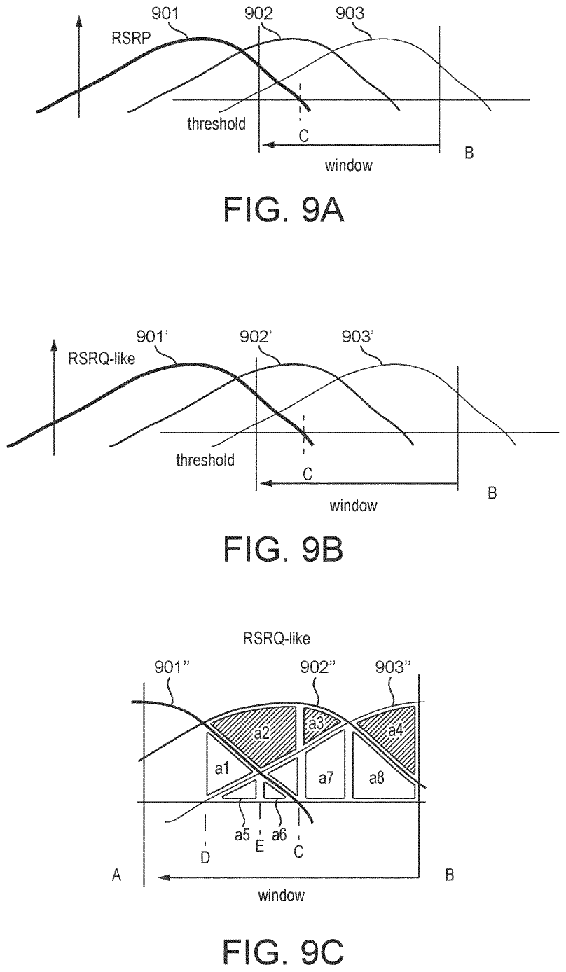

This is illustrated with respect to FIGS. 9A and 9B.

FIG. 9A illustrates how an RSRP varies for a serving cell 901, a first target cell 902 and a second target cell 903 during a window. The flat line represents a threshold RSRP level (which may be set in absolute terms, e.g., at −80 dBm). The RSRP level of the serving cell may drop below the threshold at time instance C (which is within the duration of the time window). In this example of FIG. 9A, the minimum connectivity condition of the serving cell is the RSRP value.

FIG. 9B illustrates how an RSRQ-like parameter varies for a serving cell 901′, a first target cell 902′ and a second target cell 903′ during a window. The flat line represents a threshold RSRQ-like level (which may be set in absolute terms). The RSRQ-like level of the serving cell may drop below the threshold at time instance C (which is within the duration of the time window). In this example of FIG. 9B, the minimum connectivity condition of the serving cell is the RSRQ-like value. The RSRQ-like value may be defined as, for example, an RSRP ratio of a beam under evaluation to a sum of the RSRP value of all other beams belonging to different cells. The threshold for this RSRQ-like measure may be set to a parameter configured by the network and/or operator, Qout.

As a third example, the viability configuration may comprise a rule to select target cell. For example, the UE may be configured to select (and autonomously initiate a mobility procedure to) a target cell using a rule comprised in the viability configuration. However, it is understood that the UE may simply provide the source cell with an indication of its findings in some examples.

For example, a cell that has a longest period of connectivity right after serving cell no longer satisfies minimal connectivity may be selected as the target cell. In other words, when a threshold is used for the minimum connectivity condition, there may be provided a rule that determines which of the candidate target cells has the longest connectivity starting at C.

As another example, an estimate of absolute performance of candidate target cells is used to select a target cell. Absolute values of performance where candidate is selected may be integrated over a time period during which a candidate target cell would be selected to act as a serving cell of the UE. The candidate target cell may be selected as the candidate cell that is determined to have a best performance as a serving cell to the UE.

An example of this is provided below in relation to FIG. 9C. FIG. 9C illustrates how an RSRQ-like parameter varies for a serving cell 901″, a first target cell 902″ and a second target cell 903″ during a window. The flat line represents a threshold RSRQ-like level (which may be set in absolute terms). The RSRQ-like level of the serving cell may drop below the threshold at time instance C (which is within the duration of the time window). In this example of FIG. 9C, the minimum connectivity condition of the serving cell is the RSRQ-like value. The RSRQ-like value may be defined as, for example, an RSRP ratio of a beam under evaluation to a sum of the RSRP value of all other beams belonging to different cells.

In the example of FIG. 9C, the evaluation may be performed as following.

First, it is determined that a serving cell 901″ will no longer be viable after C.

Second, it is determined that candidate target cells 902″ and 903″ fulfil a minimum connectivity for acting as a serving cell to the UE.

Third, handover times between the serving cell and each of the candidate cells determined during the preceding step are determined. For example, in the example, the handover time for handing over from the serving cell 901″ to the first target cell 902″ is at time D, while the handover time for handing over from the serving cell 901″ to the second target cell 903″ is E.

Fourth, when the first target cell 902″ is selected for consideration, a performance measure would be determined as a1+a2 . . . +a8-a4.

Fifth, when the second target cell 903″ is selected for consideration, a performance measure would be determined as a1+a2+ . . . +a8-a2-a3.

Sixth, it is determined that the first target cell 902″ is selected as the target cell when a2+a3>a4. In other words, the first target cell 902″ is selected when a difference in the RSRQ-like metric compared to the next strongest integrated over the time when the first target cell is strongest is greater than a difference in the RSRQ-like metric compared to the next strongest integrated over the time when the second target cell is strongest.

In this example, it is determined at time A to handover to the first target cell at time D as a2+a3>a4. When the window is advancing, and a4>a2+a3 becomes bigger, the second target cell 903″ would be selected in favour of the first target cell 902″. In such a case, the handover at point would not be executed.

Another performance measure could be an estimated throughput. The estimated throughput may be, for example, based on an ideal/Shannon mapping of RSRQ estimate to throughput.

As a fourth example, the viability configuration may comprise a rule to select a target handover time instance.

For example, the handover time may be selected as the point when the predicted signal of the target cell becomes better than the predicted serving cell by more than an offset amount. The evaluation of potential handovers in the prediction window may contain more than one hypothesis as to which cell would be serving. That is, an evaluation of the prediction window may yield all potential handover times (e.g., all crossing points of the predicted cell strength curves).

As predictions may be jittery, for execution a condition may be defined to minimize the likelihood of handovers being performed as a result of erroneous prediction. For example, this condition may be defined as abs (predicted time—current time)<eps, where eps can be the measurement interval. Depending on the prediction implementation, the abs ( ) operation may not be necessary.

As a fifth example, the viability configuration may comprise a rule to derive cell viability from beam measurements. The cell strength may be derived from the cell's beam strengths. The cell strength may be for instance set as maximal cell beam strength, or as average over the cell's N-best beams, where N is a parameter configured by the network.

The viability configuration may comprise a method to derive the wanted outcome in a 2-step manner. In a first step, the UE is instructed to predict a window identifying the relative strength of cells, as well as a window to predict where the cells are above an absolute threshold. These two predicted windows are sufficient for the UE to determine, in the second step, possible HO times for a parameterization offset=0 and Time to Trigger (TTT)=0.

The configuration received during 8002 may also define what the UE delivers as a viability evaluation during 8008. The UE may be configured to deliver evaluation outcomes.

For example, the UE may be configured to signal predicted event triggers (such as predicted A3 or A2 if legacy triggers were used in the configuration) to the network during 8008. This is illustrated in the following example of example of how to specify an A3-like condition for the prediction window in RRC specifications.

A Predicted A3 event relates to an event in which it is predicted that a neighbouring candidate cell becomes better than the signal predicted to be provided by a PCell and/or PSCell by more than a threshold amount. The contained predictedEventA3 may be applied to pairs of possible future serving and/or neighbour cells. In particular, the information element “ReportConfigNR” currently defined in New Radio may be enhanced with a new report Type, which is illustrated in bold in the following.

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| rxTxPeriodical-r17 | RxTxPeriodical-r17, |

```
      predictionWindowBased
    predictionWindowBasedConfig-r19xy
  }
}
```

| | |
|---|---|
| predictionWindowBasedConfig-r19xy ::= | SEQUENCE { |
| predictedEventId-r19xy | CHOICE { |
| predictedEventA3-r19xy | SEQUENCE { |
| a3-Offset-r19xy | MeasTriggerQuantityOffset, |
| hysteresis-r19xy | Hysteresis, |
| timeToTrigger-r19xy | TimeToTrigger, |
| predictedWindowDuration | ENUMERATED |
| {onesec,oneptfivesec,twosec,...} | }, |

```
    ...
  },
```

| | |
|---|---|
| rsType-r19xy | ENUMERATED {ssb}, |
| reportQuantityCell-r19xy | ENUMERATED {rsrp}, |
| maxReportCells-r19xy | INTEGER (1..maxCellReport), |

...
}

When configured by the network, the UE may be able to evaluate a predicted event (e.g., A3 indicated by predictedEventA3 within a prediction window given by predictionWindowDuration. The evaluation begins by considering a pair of the current PCell as a source cell and a target cell (measured based on the corresponding measObjectNR). When the given predicted event (e.g., A3) is considered met, the UE continues evaluation of the given predicted event (e.g., A3) for the rest of the prediction window by considering the target cell as the new source cell and continuing the evaluation by forming source and target cell PCell pairs. All such beam pairs that are found by the UE within the given prediction window may be reported to the network during 8008. For each such reported pair the UE may also report a predicted time when A3 is triggered, and a predicted time of stay. The predicted time of stay may be computed by the UE as the time duration measured between changing of the PCell within the given prediction window.

As another example, the UE may be configured to signal an indication of cells that are viable for use as a serving cell to the UE after the UE's current serving cell is no longer viable.

As another example, the UE may be configured to signal an indication of distinct windows within the prediction window in which different target cells are viable for selection as a serving cell by the UE. Windows, in which multiple conditions are satisfied for an evaluated cell are discussed below.

As an aside, it is noted that the UE may be configured to provide such a report to the network when the network performs the final evaluation and determines which target cell to select as a handover target, which may not always be the case.

Therefore, the UE may be configured to provide the network with a list of cells that were identified as potential target (and their respective predicted possible handover times). Those cells can be skipped in favor of the selected target cell. Optionally and alternatively, the UE may autonomously determine the next target cell within a specific time window and a target handover time. This latter signaling may utilize less bandwidth than when the network makes a final decision, and is suitable for autonomous (e.g., conditional handover-style) handover procedures, as well as network-decided handovers.

During 8003, the UE 801 signals the serving access node 802. This signalling may comprise a cell edge measurement report. The cell edge measurement report may be configured, for example, prior to, during, or after 8001, using known mechanisms. For example, the cell edge measurement report may be configured as A3 events are currently configured.

During 8004, the serving access node 802 signals the UE. This signalling may comprise an instruction to the UE initiate a window prediction mechanism according to the configurations of 8001 and 8002.

During 8005, the UE implements a prediction window. Although this is implementation-specific, an example way in which the prediction window may be implemented is provided below.

In this example, the UE carries out a prediction of RSRP for various reference signals within the time duration defined by the window. This may be performed using, for example, a convolutional long-short-term memory (neural network type) (LSTM-RNN), considering past RSRP sequence and beam identifier(s) sequence as inputs (e.g., using RSRP measurements that were collected by the UE over time). The model used for prediction may be provided by the network to the UE(s). The prediction window for RSRP may comprise a set of predicted RSRP sequences for different cells. The input to the model may thus comprise respective sequences of RSRP associated with multiple cells.

In an example, the input and output of this convolutional LSTM-RNN can be as follows:

### Input:

past recorded RSRP values sequence
past recorded Beam identifier sequence

### Output:

predicted future RSRP value time sequence of different cells
predicted future Beam identifier time sequence of different cells

It is understood that the “past” and “future” may, but do not necessarily have to comprise or be limited to consecutive times to a current time window.

This convolutional LSTM-RNN neural network may be trained within a specific coverage area. For example, the neural network may be trained when UEs are at a cell edge. The neural network may be re-trained for a different coverage area. The output of the LSTM-RNN calculation may be input to the UE.

During 8006, the UE determines validity of the prediction of 8005 (e.g., the UE determines a level of confidence in the prediction of 8005). Although how the UE performs this is implementation-specific, at least one possible example is illustrated below.

During 8006, the UE is carrying out a confidence evaluation of its prediction of 8005. The UE may perform that by predicting a past window and comparing it to the observed measurements. The UE may compute the confidence as the percentage of samples that fall within a 1 dB margin.

The UE may be configured to evaluate the prediction according to the viability condition only when a minimum confidence level is reached. The minimum confidence level may use a value of 95%.

During 8007, the UE determines and evaluates viability configuration outcomes. Although this is implementation specific, an example of how this may be performed is illustrated below, with reference to FIG. 10. In this example of FIG. 10, the UE evaluates different conditions contained in the viability configuration to later deliver to the network an indication of time periods within which the conditions are met:

FIG. 10 illustrates how an RSRP or an RSRQ-like metric varies for a serving cell 1001, a first target cell 1002 and a second target cell 1003 during a window. The flat line represents a threshold RSRP/RSRQ-like level.

During this example, the RSRP/RSRQ-like level of the serving cell may drop below the threshold at time instance C, the RSRP/RSRQ-like level of the first target cell 1002 becomes larger than the RSRP/RSRQ-like level of the serving cell 1001 at time instance E, the RSRP/RSRQ-like level of the second target cell 1003 becomes larger than the RSRP/RSRQ-like level of the serving cell 1001 at time instance D, the RSRP/RSRQ-like level of the second target cell 1003 becomes larger than the RSRP/RSRQ-like level of the first target cell 1002 at time instance G, the RSRP/RSRQ-like level of the second target cell 1003 becomes larger than the threshold level at time instance F, and the RSRP/RSRQ-like level of the first target cell 1002 becomes less than the threshold level at time instance H. All of these time instances are within the window.

Using the predictions of time instances indicated above with reference to FIG. 10, the UE may determine that:
periods above threshold: serving cell 1001: until C; the first target cell 1002: until H; the second target cell 1003: from F until H
serving cell 1001 vs the first target cell 1002: E; the serving vs the second target cell 1003: D
the first target cell 1002 vs the second target cell 1003: G

From that information the network can determine the second target cell 1003 as the desired target.

The UE 801 may be further provide an indication of which cell is strongest (including at which times).

During 8008, the UE 801 signals the serving access node 802.

This signalling may indicate that the UE 801 has performed its evaluations.

The information provided in the signalling may depend on the type of mobility operations being performed.

For example, in general, there may be a network controlled mobility event and a UE controlled mobility event.

In respect of a network controlled mobility event, the UE may be configured to provide the serving access node with information indicating values of measurements collected by the UE. This information may comprise information for enabling the serving access node to determine potential handover target cells for the UE. For example, the information may indicate potential handover target cells for a future time, and/or indicating which cells are providing the UE with a reference signal having a signal power and/or quality that is larger than a predetermined threshold, and/or which cells are providing the UE with a strongest reference signal in different situations or at different times, which allows the serving access node to derive potential handover targets. In this case, the network decides the handover target and handover time, and sends a handover command to the UE at the determined handover time.

In respect of a UE controlled mobility event (e.g., conditional handover), the UE identifies at least one potential target cell to the network as being a potential handover target. The network subsequently prepares those identified target cells for handover to the UE, and provides the UE with respective execution conditions for handing over to each of those target cells. The execution conditions are also referred to as A3-triggers. When at least one execution condition is fulfilled, the UE can autonomously initiate handover to the respective target cell associated with that at least one execution condition without further signalling from the serving access node. In the present case, the UE may identify potential target cells using the signal variation predictions and viability configuration previously provided at the UE. The UE does not necessarily select a first possible handover target.

Examples of information that may be provided in the signalling of 8008 is now discussed.

This signalling may provide the serving access node with the results of the evaluations of 8007. For example, this signalling may provide the serving access node with an indication of the time instances at which the different measured cells are predicted to be: larger than a threshold amount within the window, smaller than the threshold amount within the window, and/or when different cells become stronger than other cells in the group of cells being evaluated. As another example, this signalling may additionally comprise an indication of which cell is strongest (including at which time instances).

As time progresses and the window prediction is updated, the target handover time as well as the target cell may change. This signalling of 8008 may therefore provide an update to a previously signalled indication (e.g., when 8005 to 8010 are repeated on a loop). When an update is provided, the UE may determine to omit signalling some changes when the UE determines those changes to be insignificant. For example, the UE 801 may determine a change to be insignificant when a target time changes by less than a predetermined amount (e.g., less than eps2, where eps2 can be 2*eps and eps can be half the duration of a reference signal interval).

The following illustrates how the currently defined measurement information element may be supplemented for reporting such results, although it is understood that this is merely one example, and that the measurement(s) may be reported using different mechanisms to the example provided below.

In the present example, the NR MeasResults information element is enhanced with a new entry that will hold the results of the viability configuration. For example, the results may correspond to the predicted A3 events in the future window, with hypothetical serving cell choices.

The information element MeasResults covers measured results for intra-frequency, inter-frequency, inter-RAT mobility and measured results for NR sidelink communication. The newly added fields to this information are provided in bold below.

### MeasResults Information Element

-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- Contains PC5 SL- |

```
MeasResultListRelay-r17
  }
      ...,
    predictionWindowBasedMeasResults-r19xy
    PredictionWindowBasedMeasResults-r19xy
}
```

| | |
|---|---|
| PredictionWindowBasedMeasResults-r19xy ::= | SEQUENCE { |
| PredictedMeasResultListNR-r19xy ::= | SEQUENCE (SIZE |

(1..maxPredCellPairs-r19xy)) OF PredictedMeasResultNR-r19xy
...
}

| | |
|---|---|
| PredictedMeasResultNR-r19xy::= | SEQUENCE { |
| predictedSrcPhysCellId-r19xy | PhysCellId, |
| predictedSrcSSB-Cell-r19xy | MeasQuantityResults, |
| predictedTgtPhysCellId-r19xy | PhysCellId, |
| predictedTgtSSB-Cell-r19xy | MeasQuantityResults, |
| predictedTimeOfStay-r19xy | INTEGER (1..64) - |

Unit of 500 msec
}

| | |
|---|---|
| maxPredCellPairs-r19xy | INTEGER ::= 32 -- Maximum number of Cell pairs |

reported by the UE

During 8009, the serving access node 802 performs its own evaluation of the information provided during 8008.

During 8010, the UE and serving access node 802 perform a prediction loop end and condition evaluation. For instance, if the UE is moved out of the cell-edge area, the prediction loop no longer needs to be executed and so may be stopped. In other words, during 8010, the UE and serving access node determine whether or not the UE may cease its signal prediction assessment(s).

During 8011, the serving access node 802 signals the target access node 803. This signalling may prepare the target access node 803 for a potential handover. For example, the network may use the report to prepare the target at the network's right time.

In one implementation, the UE may deliver information indicating a basic set of events (e.g., when the relative cell strengths of different cells interchange) to the serving access node. This information may provide the network with the greatest amount of flexibility for determining how and when to trigger the UE to perform a handover.

When the UE has delivered information in its report information relating to all potential handover targets within the prediction window, the serving access node may select a target cell from among those potential handover targets. This may be performed, for example, by determining which handover would result in the minimum interruption time to the UE. The serving network node select a single one of these potential handover targets as a final handover target. The serving access node may signal an indication of the final handover target to the UE for causing the UE to perform handover to the final handover target.

When the UE has delivered information in its report information relating to a limited number of potential handover targets within the prediction window (e.g., one or two potential handover targets), the serving network node may obtain further information to use when selecting which of these potential handover targets to select. For example, the serving access node may obtain information relating to a current and/or predicted load being handled by each of those potential handover target(s). The serving network node may use this additional information to select a single one of these potential handover targets as a final handover target. The serving access node may signal an indication of the final handover target to the UE for causing the UE to perform handover to the final handover target.

The operations may the proceed back to 8005 as the prediction window is looped. This prediction loop may be considered to be a prediction of a future window of RSRP (or RSRQ) and evaluation of the viability condition in a continuous manner as time progresses.

The continuous evaluation may be initiated and stopped by the serving access node 802 (e.g., initiated during 8004, and stopped when the UE has moved away from a cell edge (not shown)). The serving access node 802 may initiate the prediction loop based on recognizing that the UE is approaching cell-edge. The serving access node may recognize that the UE is approaching a cell-edge based on the receipt, from the UE, of periodic or triggered neighbour measurements or Timing Advance (TA) measurements, or from the UE's position as known by the network. The serving access node may configure a corresponding trigger to the UE and the UE then starts the predictions, while also indicating to the network that it did so. Likewise, the network may pause the prediction loop. The network may configure the UE to run the prediction loop with every new incoming measurement.

The method then performs either 8012 or 8013.

8012 relates to a network-initiated handover in which the serving access node signals to the UE 801 an instruction to handover to the target access node 803.

This may be performed using baseline handover techniques (e.g., Radio Resource Control (RRC)-level signaling).

This may alternatively or additionally be performed in the context of LTM, in which a UE delivers L1 measurements to the serving access node, and the serving access node issues a handover command using a Medium Access Control Control element (MAC CE) in response to these measurements.

8013 relates to a UE-initiated handover from the serving access node 802 to the target access node 803. This UE-initiated handover may be, for example, a conditional handover preconfigured at the UE by the serving access node. As the serving access node 802 is aware of the target handover time (range), the serving access node may have previous sent the UE a “prohibit” message or handover command if the serving access node 802 disagrees with the UE's indicated findings (reported to the serving access node 802 during 8008).

The following considers the application of the above mechanism to the example of FIG. 10 and FIG. 6.

Some of the salient details of FIG. 10 for the present example are as follows.

The window is predicted between time instances A and B. At point C the serving cell is no longer meeting the viability condition. Starting at C, the second target cell 1002 has the longest connectivity until the end of the prediction window, B, and is selected as a target cell for handover with a selected handover target time of D. In the example of FIG. 6, which illustrates an example simulation at the serving cell, the gaps in the traces indicate where handover happened, and measurements could not be collected. In FIG. 6, two handovers happen within 400 msec. The first handover could have been avoided. This simulation scenario comprised UE moving at speed 120 km/h, and a carrier frequency at 30 GHz. Handovers were initiated when neighbour beam becomes better than serving beam by more than an offset of 3 dB.

The above example of FIG. 6 (where handover to the second target cell at time D), is evaluated by checking every timestep's conditions. It is assumed A=100 msec, and B=600 msec. Point C, where serving is no longer viable (assuming RSRP thresh −80 dB), is assumed to happen at time 320 msec. The longest viable cell between C and B after that is the second target cell. This means there is no need to handover to the first target cell 1002. Time D (at which handover from the serving cell to the second target cell) follows sometime between 240 and 320 msec.

As mentioned above, the UE's evaluation of the viability condition may be implementation specific. In general though, the UE may be configured to predict a window of RSRP (or a similar metric of a signal strength and/or quality), and run an algorithm to evaluate the expected condition of the signals from different cells within that window. The serving network node is primarily concerned with the parameterization of the viability condition, and the outcome of the evaluation. In principle it is possible for the UE to use its proprietary algorithm to derive the target cell and time.

Further, the above examples the network was instructing the UE to carry out a cell switch. However, it is understood that the presently described techniques may be equally applied to network-initiated and UE-initiated mobility operations.

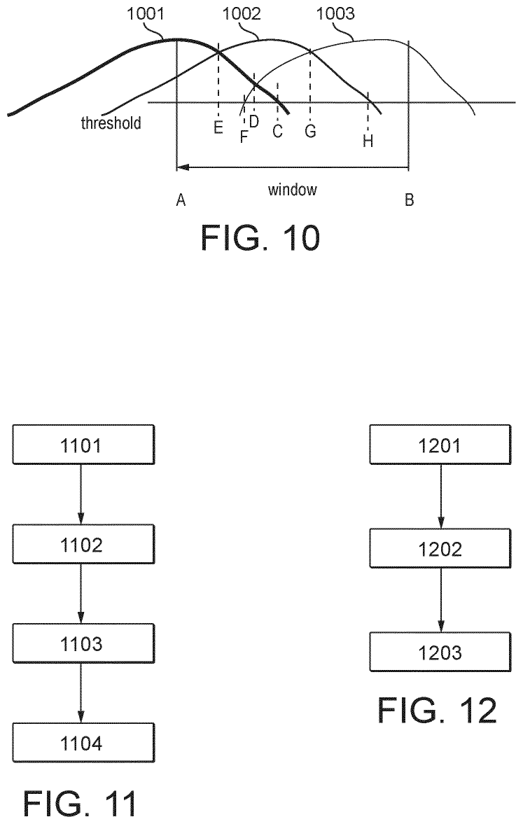

FIGS. 11 and 12 illustrate operations that may be performed by apparatus described herein. These operations reflect features of the above-mentioned examples. Therefore features of the below may find correspondence with features of the above-mentioned examples, and may therefore be combined with features mentioned above (in some examples).

FIG. 11 illustrates operations that may be performed by an apparatus of a user equipment.

During 1101, the user equipment receives, from a network (e.g., from an access network node, such as a serving network node), an indication of a first time duration and an indication of at least one metric to be predicted within the first time duration for at least a serving cell and a plurality of target cells of the network. The at least one metric to be predicted may be at least one metric of a respective beam transmitted by the serving cell and the plurality of target cells. The respective beam may be a respective reference signal of the serving cell and the plurality of target cells.

During 1102, the user equipment receives, from the network, an indication of how to identify potential handover opportunities between the serving cell and at least one of the plurality of target cells within the first time duration using the at least one metric, the potential handover opportunities comprising respective combinations of a target cell identity and a time instance for executing handover.

During 1103, the user equipment identifies, for the first time duration commencing at a first time, a first set of potential handover opportunities between the serving cell and at least one of the plurality of target cells within the first time duration using the at least one metric. The first set may be equal to one (e.g., comprise a single potential handover opportunity). The first set may be greater than one (e.g., comprise multiple potential handover opportunities).

During 1104, the user equipment signals an indication of at least one of said first set of potential handover opportunities to the network.

The signalling the indication of at least one of said first set of potential handover opportunities to the network may comprise: signalling an indication of a plurality of said first set of potential handover opportunities to the serving cell; receiving, from the serving cell, an indication of a single potential handover opportunity of the plurality of first set of potential handover opportunities; and performing a handover to the target cell identified by the single potential handover opportunity at the time instance indicated by the single potential handover opportunity.

The identifying may comprise, for each target cell identified by said plurality of handover opportunities, predicting values of the at least one metric at different time instances within said first duration of time to form respective predicted metrics.

The indication of said plurality of first set of potential handover opportunities signalled to the serving cell may comprise, for each target cell identified by said plurality of first set of potential handover opportunities, at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The signalling the indication of at least one of said first set of potential handover opportunities to the network may comprise: signalling an indication of a single potential handover opportunity to the serving cell; and performing a handover to the target cell identified by the single potential handover opportunity at the time instance indicated by the single potential handover opportunity.

The identifying may comprise: predicting, for each target cell identified by the first set of potential handover opportunities, values of the at least one metric at different time instances within said first duration of time to form respective predicted metrics; and selecting the single potential handover opportunity by selecting the single potential handover opportunity using the predicted metrics.

The at least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount. The offset amount may be dependent on the radio network conditions as the real handover margins are of interest. The offset may be zero. The offset may be more than zero.

The user equipment may abstain from performing a handover at a first one of the handover opportunities of the first set, and perform a handover to a selected one of the plurality of target cells at a second one of the handover opportunities, the second one of the handover opportunities occurring later in time than the first one of the handover opportunities. This abstaining and performing may be performed in respect of any of a network-initiated handover and a user equipment handover.

The user equipment may identify, for the first time duration commencing at a second time, a second set of potential handover opportunities between the serving cell and at least one of the plurality of target cells within the first time duration using the at least one metric, wherein the second time is later than the first time, and signal an indication of at least one of said second set of potential handover opportunities to the serving cell. For example, the user equipment may loop the procedure of any of the above.

The at least one metric may comprise a Reference Signal Received Power and/or a Reference Signal Received Quality.

FIG. 12 illustrates operations that may be performed by an apparatus for a serving access node providing a serving cell to a user equipment. The user equipment may be as described above in relation to FIG. 12.

During 1201, the serving access node signals, to the user equipment, an indication of a first time duration and an indication of at least one metric to be predicted within the first time duration for at least the serving cell and a plurality of target cells.

During 1202, the serving access node signals, to the user equipment, an indication of how to identify potential handover opportunities between the serving cell and at least one of the plurality of target cells within the first time duration using the at least one metric, the potential handover opportunities comprising a respective combinations of a target cell identity and a time instance for executing handover.

During 1203, the serving access node receives, from the user equipment, an indication of at least one of a first set of potential handover opportunities for handing the user equipment over from the serving cell to at least one of the plurality of serving cells within the first time duration using the at least one metric. The first set may be equal to one (e.g., comprise a single potential handover opportunity). The first set may be greater than one (e.g., comprise multiple potential handover opportunities).

The serving access node may comprise an access network node (e.g., a gNB).

The receiving the indication of at least one of said first set of potential handover opportunities may comprise: receiving an indication of a single potential handover opportunity; and causing a handover to the target cell identified by the single potential handover opportunity to be performed at the time instance indicated by the single potential handover opportunity. The causing may comprise the serving access node sending a handover command to the user equipment to instruct the user equipment to perform handover to the target cell at the time instance indicated by the single potential handover opportunity. The causing may comprise sending the user equipment a conditional handover configuration for preparing the user equipment with a conditional handover opportunity to the target cell (e.g., such that when the user equipment determines that a set of conditions associated with that conditional handover have been fulfilled, the UE initiates handover to the target cell).

The receiving the indication of at least one of said first set of potential handover opportunities may comprise: receiving, from the user equipment, an indication of a plurality of said first set of potential handover opportunities; selecting a single potential handover opportunity from said potential handover opportunities by determining that the target cell identified by the single potential handover opportunity can also provide coverage to the user equipment during a time instance associated within another of said first set of potential handover opportunities; and signalling, to the user equipment, an indication of the single potential handover opportunity of the plurality of first set of potential handover opportunities.

Said receiving an indication of at least one of a first set of potential handover opportunities may comprise receiving, for each target cell identified by the first set of potential handover opportunities, values of the at least one metric at different time instances within said first duration of time to form respective predicted metrics, and wherein said selecting the single potential handover opportunity may comprise selecting the single potential handover opportunity using the predicted metrics.

At least one of the predicted values for a target cell may comprise at least one of: an indication of a time instance within said window when the predicted metric for that target cell is larger than a threshold value; an indication of a time instance within said window when the predicted metric for that target cell is smaller than the threshold value; an indication of a time instance within said window when the predicted metric for that target cell is larger than the same metric predicted for another target cell by an offset amount; an indication of a time instance within said window when the predicted metric for that target cell is larger than the same metric predicted for the serving cell by the offset amount; an indication of a time instance within said window when the predicted metric for that target cell is less than the same metric predicted for another target cell by the offset amount; or an indication of a time instance within said window when the predicted metric for that target cell is less than the same metric predicted for the serving cell by the offset amount.

The serving network node may cause the user equipment to be handed over to the target cell identified by the single potential handover opportunity at the time instance indicated by the single potential handover opportunity.

The serving network node may cause a handover to be performed by the user equipment by: abstaining from causing a handover to be performed at a first one of the handover opportunities of the first set; and causing handover to a selected one of the plurality of target cells at a second one of the handover opportunities, the second one of the handover opportunities occurring later in time than the first one of the The serving network node may receive, from the user equipment, an indication of a second set of potential handover opportunities between the serving cell and at least one of the plurality of target cells within the first time duration, wherein second set of potential handover opportunities relates to a set of predictions made using the metric for the first time duration commencing at a second time, the second time is later than the first time, and cause the user equipment to be handed over to the target cell identified by at least one of the second set of potential handover opportunities at the time instance indicated by one of said second set of potential handover opportunities.

The at least one metric may comprise a Reference Signal Received Power and/or a Reference Signal Received Quality.

The presently described techniques allow the avoidance of unnecessary handover. This can help to minimize any interruption time resulting from a handover, signaling between network nodes, and tasks related to preparation of nodes, and/or, in case new events are defined and legacy events are not configured, signaling between different entities.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software code, logic or any combination thereof. For example, some aspects may be implemented in hardware, while other aspects may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 11 and/or FIG. 12, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further implementation comprising a combination of one or more implementations with any of the other implementations previously discussed.

1. A user equipment, comprising at least one processor; and at least one memory comprising software code that, when executed by the at least one processor, causes the user equipment to perform:
receiving, from a network, an indication of a first time duration and an indication of at least one metric to be predicted within the first time duration for at least a serving cell and a plurality of target cells of the network;
receiving, from the network, an indication of how to identify potential handover opportunities between the serving cell and at least one of the plurality of target cells within the first time duration using the at least one metric, the potential handover opportunities comprising respective combinations of a target cell identity and a time instance for executing handover;
identifying, for the first time duration commencing at a first time, a first set of potential handover opportunities between the serving cell and at least one of the plurality of target cells within the first time duration using the at least one metric; and
signalling an indication of at least one of said first set of potential handover opportunities to the network.

2. The user equipment as claimed in claim 1,
wherein the signalling the indication of at least one of said first set of potential handover opportunities to the network comprises:
signalling an indication of a plurality of said first set of potential handover opportunities to the serving cell;
receiving, from the serving cell, an indication of a single potential handover opportunity of the plurality of first set of potential handover opportunities; and
performing a handover to the target cell identified by the single potential handover opportunity at the time instance indicated by the single potential handover opportunity.

3. The user equipment as claimed in claim 2, wherein the identifying comprises for each target cell identified by said plurality of handover opportunities, predicting values of the at least one metric at different time instances within said first time duration to form respective predicted metrics.

4. The user equipment as claimed in claim 2, wherein the identifying comprises, for each target cell identified by said plurality of handover opportunities, predicting values of the at least one metric at different time instances within said first time duration to form respective predicted metrics; and wherein the indication of said plurality of first set of potential handover opportunities signalled to the serving cell comprises, for each target cell identified by said plurality of first set of potential handover opportunities, at least one of:
an indication of a time instance within said first time duration when the predicted metric for that target cell is larger than a threshold value;
an indication of a time instance within said first time duration when the predicted metric for that target cell is smaller than the threshold value;
an indication of a time instance within said first time duration when the predicted metric for that target cell is larger than the same metric predicted for another target cell by an offset amount;
an indication of a time instance within said first time duration when the predicted metric for that target cell is larger than the same metric predicted for the serving cell by the offset amount;
an indication of a time instance within said first time duration when the predicted metric for that target cell is less than the same metric predicted for another target cell by the offset amount; or
an indication of a time instance within said first time duration when the predicted metric for that target cell is less than the same metric predicted for the serving cell by the offset amount.

5. The user equipment as claimed in claim 1, wherein the signalling the indication of at least one of said first set of potential handover opportunities to the network comprises:
signalling an indication of a single potential handover opportunity to the serving cell; and
performing a handover to the target cell identified by the single potential handover opportunity at the time instance indicated by the single potential handover opportunity.

6. The user equipment as claimed in claim 5:
wherein said identifying comprises predicting, for each target cell identified by the first set of potential handover opportunities, values of the at least one metric at different time instances within said first time duration to form respective predicted metrics; and
selecting the single potential handover opportunity by selecting the single potential handover opportunity using the predicted metrics.

7. The user equipment as claimed in claim 5, wherein said identifying comprises predicting, for each target cell identified by the first set of potential handover opportunities, values of the at least one metric at different time instances within said first time duration to form respective predicted metrics; and
selecting the single potential handover opportunity by selecting the single potential handover opportunity using the predicted metrics; and wherein at least one of the predicted values for a target cell comprises at least one of:
an indication of a time instance within said first time duration when the predicted metric for that target cell is larger than a threshold value;
an indication of a time instance within said first time duration when the predicted metric for that target cell is smaller than the threshold value;
an indication of a time instance within said first time duration when the predicted metric for that target cell is larger than the same metric predicted for another target cell by an offset amount;
an indication of a time instance within said first time duration when the predicted metric for that target cell is larger than the same metric predicted for the serving cell by the offset amount;
an indication of a time instance within said first time duration when the predicted metric for that target cell is less than the same metric predicted for another target cell by the offset amount; or
an indication of a time instance within said first time duration when the predicted metric for that target cell is less than the same metric predicted for the serving cell by the offset amount.

8. The user equipment as claimed in claim 1, wherein the software code, when executed by the at least one processor, causes the user equipment to perform:
abstaining from performing a handover at a first one of the handover opportunities of the first set; and
performing a handover to a selected one of the plurality of target cells at a second one of the handover opportunities, the second one of the handover opportunities occurring later in time than the first one of the handover opportunities.

9. The user equipment as claimed in claim 1, wherein the software code, when executed by the at least one processor, causes the user equipment to perform:
identifying, for the first time duration commencing at a second time, a second set of potential handover opportunities between the serving cell and at least one of the plurality of target cells within the first time duration using the at least one metric, wherein the second time is later than the first time; and
signalling an indication of at least one of said second set of potential handover opportunities to the serving cell.

10. An access node configured to provide a serving cell to a user equipment, the access node comprising at least one processor; and at least one memory comprising software code that, when executed by the at least one processor, causes the user equipment to perform:
signalling, to the user equipment, an indication of a first time duration and an indication of at least one metric to be predicted within the first time duration for at least the serving cell and a plurality of target cells;
signalling, to the user equipment, an indication of how to identify potential handover opportunities between the serving cell and at least one of the plurality of target cells within the first time duration using the at least one metric, the potential handover opportunities comprising a respective combinations of a target cell identity and a time instance for executing handover; and
receiving, from the user equipment, an indication of at least one of a first set of potential handover opportunities for handing the user equipment over from the serving cell to at least one of the plurality of serving cells within the first time duration using the at least one metric.

11. The access node as claimed in claim 10, wherein the receiving the indication of at least one of said first set of potential handover opportunities comprises:
receiving an indication of a single potential handover opportunity; and
causing a handover to the target cell identified by the single potential handover opportunity to be performed at the time instance indicated by the single potential handover opportunity.

12. The access node as claimed in claim 10, wherein the receiving the indication of at least one of said first set of potential handover opportunities comprises:
receiving, from the user equipment, an indication of a plurality of said first set of potential handover opportunities;
selecting a single potential handover opportunity from said potential handover opportunities by determining that the target cell identified by the single potential handover opportunity can also provide coverage to the user equipment during a time instance associated within another of said first set of potential handover opportunities; and
signalling, to the user equipment, an indication of the single potential handover opportunity of the plurality of first set of potential handover opportunities.

13. The access node as claimed in claim 12:
wherein said receiving an indication of at least one of a first set of potential handover opportunities comprises receiving, for each target cell identified by the first set of potential handover opportunities, values of the at least one metric at different time instances within said first time duration to form respective predicted metrics; and
wherein said selecting the single potential handover opportunity comprises selecting the single potential handover opportunity using the predicted metrics.

14. The access node as claimed in claim 13, wherein said receiving an indication of at least one of a first set of potential handover opportunities comprises receiving, for each target cell identified by the first set of potential handover opportunities, values of the at least one metric at different time instances within said first time duration to form respective predicted metrics; and wherein said selecting the single potential handover opportunity comprises selecting the single potential handover opportunity using the predicted metrics; and wherein at least one of the predicted values for a target cell comprises at least one of:
an indication of a time instance within said first time duration when the predicted metric for that target cell is larger than a threshold value;
an indication of a time instance within said first time duration window-when the predicted metric for that target cell is smaller than the threshold value;
an indication of a time instance within said first time duration when the predicted metric for that target cell is larger than the same metric predicted for another target cell by an offset amount;
an indication of a time instance within said first time duration when the predicted metric for that target cell is larger than the same metric predicted for the serving cell by the offset amount;
an indication of a time instance within said first time duration when the predicted metric for that target cell is less than the same metric predicted for another target cell by the offset amount; or
an indication of a time instance within said first time duration when the predicted metric for that target cell is less than the same metric predicted for the serving cell by the offset amount.

15. The access node as claimed in claim 11, wherein the software code, when executed by the at least one processor, causes the user equipment to perform:
causing the user equipment to be handed over to the target cell identified by the single potential handover opportunity at the time instance indicated by the single potential handover opportunity.

16. The access node as claimed in claim 10, wherein the software code, when executed by the at least one processor, causes the user equipment to perform:
causing a handover to be performed by the user equipment by:
abstaining from causing a handover to be performed at a first one of the handover opportunities of the first set; and
causing handover to a selected one of the plurality of target cells at a second one of the handover opportunities, the second one of the handover opportunities occurring later in time than the first one of the handover opportunities.

17. The access node as claimed in claim 10, wherein the software code, when executed by the at least one processor, causes the user equipment to perform:
receiving, from the user equipment, an indication of a second set of potential handover opportunities between the serving cell and at least one of the plurality of target cells within the first time duration, wherein second set of potential handover opportunities relates to a set of predictions made using the metric for the first time duration commencing at a second time, the second time is later than the first time; and
causing the user equipment to be handed over to the target cell identified by at least one of the second set of potential handover opportunities at the time instance indicated by one of said second set of potential handover opportunities.

18. The user equipment as claimed in claim 1, wherein the at least one metric comprises a Reference Signal Received Power and/or a Reference Signal Received Quality.

19. A method for a user equipment, the method comprising:
receiving, from a network, an indication of a first time duration and an indication of at least one metric to be predicted within the first time duration for at least a serving cell and a plurality of target cells of the network;
receiving, from the network, an indication of how to identify potential handover opportunities between the serving cell and at least one of the plurality of target cells within the first time duration using the at least one metric, the potential handover opportunities comprising respective combinations of a target cell identity and a time instance for executing handover;
identifying, for the first time duration commencing at a first time, a first set of potential handover opportunities between the serving cell and at least one of the plurality of target cells within the first time duration using the at least one metric; and
signalling an indication of at least one of said first set of potential handover opportunities to the network.

20-22. (canceled)

23. The access node as claimed in claim 10, wherein the at least one metric comprises a Reference Signal Received Power and/or a Reference Signal Received Quality.
